(19) United States
(12) Patent Application Publication
(10) Pub. No.: US 2026/0276895 A1
(43) Pub. Date: Sep. 17, 2026

(54) 2D FIBER ARRAY PACKAGING FOR OPTICAL INTERFACES

(71) Applicant: Applied Materials, Inc., Santa Clara, CA (US)

(72) Inventors: Jinxin Fu, Santa Clara, CA (US); Yupeng Zhu, San Jose, CA (US); Yannanqi Li, Santa Clara, CA (US); Paul Meissner, Santa Clara, CA (US)

(21) Appl. No.: 19/554,988

(22) Filed: Mar. 3, 2026

Related U.S. Application Data
(60) Provisional application No. 63/770,880, filed on Mar. 12, 2025.

(51) Int. Cl. G02B 6/32; G02B 6/30

(52) U.S. Cl. CPC G02B 6/322; G02B 6/305

(57) ABSTRACT

An optical interface includes a plurality of inner cores of waveguides, an array of turning elements, wherein each inner core the plurality of inner cores is associated with a respective turning element of the array of turning elements, and a plurality of spot size converters, wherein each spot size converter of the plurality of spot size converters is associated with a respective turning element of the array of turning elements.

### CLAIM OF PRIORTY

The present application claims the benefit under 35 U.S.C. §119(e) of U.S. Provisional Patent Application No. 63/770,880 filed Mar. 12, 2025, which is incorporated by reference herein.

### TECHNICAL FIELD

Embodiments of the present disclosure relate to optical systems, and more particularly to 2D fiber array packaging for a high-density optical interface.

### BACKGROUND

In an optical system, an optical signal can travel through a an optical medium such as a waveguide and/or an optical fiber. The optical fiber can be formed from an inner core made of a first material having a first index of refraction and an outer cladding made of a second material having a second index of refraction less than the first index of refraction. For example, the first material and the second material can each be formed from a different type of glass. Thus, when an optical signal traveling in a waveguide is incident on the boundary between the inner core and the outer cladding at an angle exceeding the critical angle, the optical signal can exhibit total internal reflection.

### SUMMARY

In some embodiments, an optical connector includes a first body comprising a plurality of holes, a plurality of optical cores inserted into the plurality of holes and arranged in a first two-dimensional (2D) array, and an optically transparent second body bonded to at least one of the first body or the plurality of optical cores. The second body comprises a first plurality of microlenses. Each microlens of the first plurality of microlenses aligned with a respective optical core of the plurality of optical cores such that the first plurality of microlenses are arranged in a second 2D array. A first arrangement of the first 2D array matches a second arrangement of the second 2D array.

In some embodiments, system comprises a photonic integrated circuit (PIC) comprising an optical port and an optical connector. The optical connector comprises a first body comprising a plurality of holes, a plurality of optical cores inserted into the plurality of holes and arranged in a first two-dimensional (2D) array, and an optically transparent second body bonded to at least one of the first body or the plurality of optical cores. The second body comprises a first plurality of microlenses. Each microlens of the first plurality of microlenses aligned with a respective optical core of the plurality of optical cores such that the first plurality of microlenses are arranged in a second 2D array. A first arrangement of the first 2D array matches a second arrangement of the second 2D array.

Numerous other aspects and features are provided in accordance with these and other embodiments of the disclosure. Other features and aspects of embodiments of the disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1C are diagrams of views of example systems including co-packaged optical devices, according to some aspects of the disclosure.

FIG. 2A is a block diagram of a side-view of an example system, according to some aspects of the disclosure.

FIG. 2B is a block diagram of a side-view of an example system, according to some aspects of the disclosure.

FIG. 2C is a block diagram of a side-view of an example system, according to some aspects of the disclosure.

FIG. 2D is a block diagram of a side-view of an example system, according to some aspects of the disclosure.

FIG. 3 is an illustration of a portion of fiber array, according to some aspects of the disclosure

FIG. 4A is an example fiber array, according to some aspects of the disclosure.

FIG. 4B is an example fiber array, according to some aspects of the disclosure.

FIG. 5 is a block diagram of a top-down view of an example system, according to some aspects of the disclosure.

FIG. 6A is a diagram of cross-sectional view of an example system, according to some aspects of the disclosure.

FIG. 6B is a diagram of a bottom-up view of an example optical fiber array connector 660, according to some aspects of the disclosure.

FIG. 6C is a diagram of a top-down view of the system showing example connections between the multiple inner cores including the inner core and respective ones of the turning elements including the turning element, according to some aspects of the disclosure.

FIGS. 7A-13C are diagrams of views of example devices implementing detachable optical fiber-to-waveguide coupling, according to some aspects of the disclosure.

FIG. 14 is a flowchart of an example method to fabricate a 2D array of microlenses, according to some aspects of the disclosure.

### DETAILED DESCRIPTION

Embodiments of the present disclosure relate to 2D fiber array packaging for optical interfaces. Optical communications rely on accurate alignment of optical components in an optical interface. Often as the signal transmission accuracy of the optical interface increases, the quality of the optical signal that can be communicated across the optical interface also increases. For example, as the alignment accuracy for the optical interface increases, bandwidth of the optical signal can increase, and a number of errors in the optical signal can decrease. However, as optical devices continue to get smaller to support a higher density of optical communications, the manufacturing tolerances of optical components can approach the alignment tolerances of the optical components, such that two optical components of the optical interface may not properly align due to errors in the manufacturing process which may be well within the accepted manufacturing tolerances for each individual component. Embodiments provide 2D fiber array packaging for optical interfaces that improves the alignment of components at the optical interface.

A co-packaged device (e.g., multi-chip module) can include a package substrate having multiple PICs assembled closely together. More specifically, optical components can be integrated on substrates (e.g., a silicon (Si) substrate) for fabricating large-scale PICs that co-exist with micro-electronic chips. With the use of an optical transceiver, a received optical signal can be converted to an electrical signal capable of being processed by an integrated circuit, or the processed electrical signal can be converted to an optical signal to be transmitted via an optical fiber.

Instead of ICs (e.g., microchips) that utilize electrons to process information, referred to as electronic ICs (EICs), a PIC utilizes photons (light particles) to process information. A PIC can include multiple photonic components connected on a single chip. Examples of components of a PIC include optical signal generators (e.g., lasers) to generate optical signals (e.g., light), waveguides to direct optical signals within the PIC (e.g., similar to wires used to direct electrons), modulators to modulate optical signals to encode information, and detectors to detect and decode the information from the optical signals.

A co-packaged device can include an interconnect device (“interconnect”) disposed between a first component and a second component. For example, an interconnect can be placed between a package substrate and a ball grid array. In some embodiments, an interconnect includes an interposer. An interposer is an electrical interface that routes connections between sockets or connections between the first component and the second component. An interposer can be used to connect components that may not naturally connect to one another. Some interconnects (e.g., interposers) can include multiple conductive layers (e.g., metal layers), where pairs of conductive layers are connected by at least one conductive via (“via”). For example, a first conductive layer of a first metallization level and a second conductive layer of a second metallization level can be connected by at least one via. Some interconnects (e.g., interposers) can further include multiple waveguides, optionally integrated near the conductive layers.

The waveguides of an interconnect and/or of a substrate can use evanescent wave coupling to transmit an optical signal received from an initial waveguide of the interconnect and/or substrate to a final waveguide of the interconnect and/or substrate. For example, the initial waveguide can be integrated near a bottom conductive layer of the interconnect and/or substrate, and the final waveguide can be integrated near a top conductive layer of the interconnect and/or substrate. Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

An optical connection between a fiber or fiber array and the PIC (e.g., the PIC optical waveguide), also referred to herein as a connector, can include a connection substrate having multiple grooves formed therein. Multiple respective optical fibers can be inserted and secured in the multiple grooves. Each optical fiber can be optically coupled to a respective waveguide. A connection substrate can be formed with a geometry that can provide the proper spacing to achieve optical coupling. For example, a large number of optical fiber-to-waveguide couplings may be used for a multichannel wavelength division multiplexing (WDM) optical system.

Typically, a PIC implementing a multichannel wavelength division multiplexing (WDM) system includes active components such as modulators, multiplexers, etc. For example, a given modulator can receive an optical signal from an optical signal source, and generate a modulated wave. A set of modulated waves generated from a set of optical signals can be combined using a respective multiplexer to generate a multiplexed wave for a given channel. Such one-to-one optical fiber-to-waveguide connections can use a large number of optical fiber-to-waveguide couplings for a multichannel WDM system. For example, the number of couplings can be n*m, where n is the number of optical signal sources (e.g., light sources) and m is the number of lanes of the multichannel WDM system. Accordingly, it can be difficult to scale up the number of channels in an optical system.

One challenge related to optical input/output (I/O) designs targeted for some types of architectures including PICs and optical fibers, such as artificial intelligence (AI) cluster architectures, is matching of optical bandwidth density with electrical bandwidth density with respect to optical fiber coupling to the optical I/O. In particular, the optical bandwidth density can be lower than the electrical bandwidth density at the interface, and so the bandwidth limiter can be located on the optical side.

For example, one potential optical fiber coupling solution to the optical I/O is a one-dimensional (1D) approach. One example of a 1D approach is implementing photonic IC edge coupling from embedded optical waveguides to a V-groove array of optical fibers. More specifically, a V-groove array can include a substrate having multiple V-grooves formed therein, where a V-groove is an opening that has a tapered shape in which the sides of the groove converged to a point (e.g., triangular shape). Each optical fiber can be inserted into a V-groove and secured in the V-groove using an adhesive (e.g., glue). The maximum density of these V-groove optical fiber arrays can be a function of optical fiber cladding layer size, which can limit a distance between adjacent optical fibers within the optical fiber array (e.g., optical fiber pitch).

Some surface optical signal coupling solutions can use a grating coupler, formed in a cladding layer formed on a substrate, to direct an incoming optical signal into a waveguide formed by an inner core formed within the cladding layer. However, such coupling solutions can contribute to high loss (e.g., greater than or equal to about 2 decibels (dB)) and small 1-dB bandwidth in wavelength (e.g., less than or equal to about 30 nanometers (nm)). Alternatively, some surface coupling solutions can use a turning element, such as a mirror, formed in a cavity or trench formed within the cladding layer and the substrate, to direct an incoming optical signal into the waveguide formed by an inner core formed within the cladding layer. However, such coupling solutions may include turning element (e.g., mirror) alignment and bonding, which may not meet alignment tolerances for edge coupling (e.g., 1 dB alignment tolerance is typically less than or equal to about 2 µm). Some optical signal coupling solutions may attempt to satisfy alignment tolerances by permanently coupling the optical fibers directly to the PIC. However, even these solutions may not satisfy the alignment tolerances for the target coupling performance, and have the added disadvantage of permanently bonding the optical fiber to the PIC.

For current optical I/O bandwidth enabled through photonic IC edge coupling to a fiber array, the optical bandwidth density (e.g., optical “shoreline” bandwidth density) can be limited to, e.g., about 1.4 terabits per second per millimeter (Tb/s/mm). This 1.4 Tb/s/mm optical bandwidth density can assume a maximum per-channel bit rate of 200 gigabits per second (Gb/s), a single wavelength per optical fiber, and a minimum optical fiber pitch of 127 micrometers (µm). However, the expected electrical bandwidth density (e.g., electrical “shoreline” bandwidth density) may exceed 10 Tb/s/mm. Embodiments described herein provide optical coupling solutions that increase the optical bandwidth density, optionally matching the electrical bandwidth density.

Another potential optical fiber coupling solution to the optical I/O is vertical coupling using a two-dimensional (2D) approach. One example of a 2D approach is vertically coupling a grating coupler array to a two-dimensional (2D) optical fiber array. While 2D approaches using grating coupler arrays can enable increased optical bandwidth density as compared to 1D approaches (e.g., the V-groove approach), the potential for higher loss, narrower spectral bandwidth and higher polarization sensitivity of 2D approaches using grating coupler arrays may render them nonviable solutions for scaling optical bandwidth density with electrical bandwidth density.

Aspects described herein can address these and other drawbacks by providing 2D fiber array packaging for optical interfaces. In embodiments, a fiber array is attached to a sheet of optically transparent material, after which microlenses are manufactured onto the sheet of optically transparent material. Each microlens corresponds to a respective optical fiber in the fiber array. In this way, the microlens for each fiber has a very high alignment accuracy with respect to its own respective optical fiber. As described herein, the microlens can collimate light (e.g., an optical signal) from a respective optical fiber. The collimated light can be transmitted through an optical medium, such as air, to another microlens. The receiving microlens can focus the collimated light into an optical signal. In some embodiments, the collimated light is focused to match a mode of a waveguide. In some embodiments, the collimated light is focused to match a mode field diameter (MFD) of a single mode fiber (SMF).

In some embodiments, the 2D fiber array packaging can include a bend. A bending angle of the bend can range from about 5° to about 90°. In some embodiments, the bend is achieved by bending the optical fibers. In some embodiments, the bend is achieved with one or more turning elements (e.g., turning mirrors). In some embodiments, the bend in the fiber array can be heat-treated to reduce mechanical stress on the bend. The bend in the fiber array can have a relatively small bending radius and relatively low bending loss. In some embodiments, the fibers that attach to the fiber array can have a relatively small cladding diameter fiber (e.g., approximately 70-90 µm). In some embodiments, the bend in the fiber array does not negatively affect the quality of the optical signal, or increase optical loss.

In some embodiments, the 2D fiber array packaging is configured to convert a size of an optical mode from a smaller size for propagation (e.g., within the interposer) to a larger size for optical coupling. Illustratively, the smaller size for propagation can be about a 1 µm mode field diameter (MFD), and the larger size for optical coupling can be greater than or equal to about a 5 µm MFD. To achieve this, in some embodiments, the 2D fiber array packaging implements spot size converters (SSCs) (also referred to herein as “microlenses”) to convert the size of the optical mode from the smaller size for propagation to the larger size for coupling. More specifically, each SSC can be manufactured right at the termination of an inner core of an optical fiber. This allows for an increased accuracy in placement of the microlens with respect to the inner fore of the optical fiber.

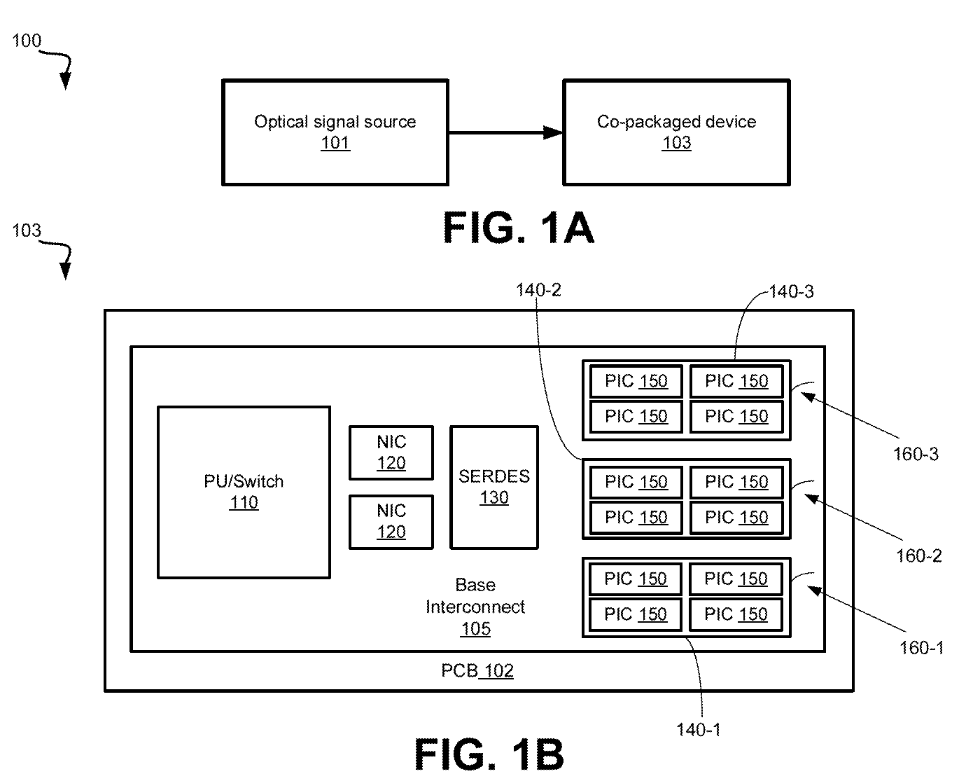

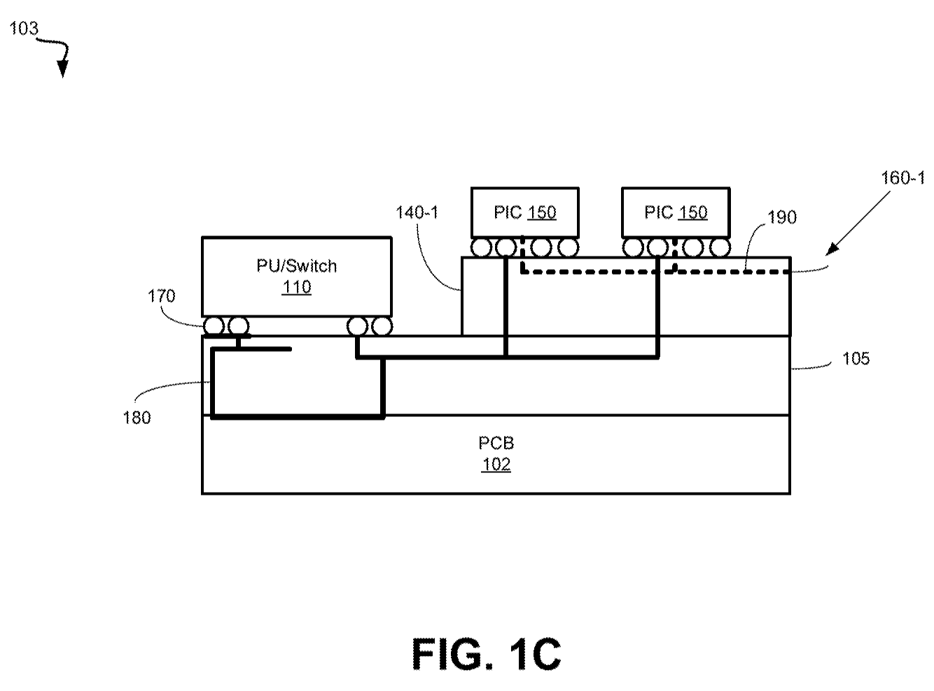

Embodiments described herein can provide for numerous other technical advantages. Manufacturing the microlens onto the fiber array based on the position of the respective optical fibers reduces the overall manufacturing tolerance for the device. This reduces the manufacturing tolerances used to align the optical fiber cores with the microlenses. The resulting manufacturing tolerances for the combined device are thus primarily dependent on manufacturing tolerances of the microlens, leading to an improved alignment between microlens arrays. The resulting improved alignment reduces optical loss, resulting in an improved transmission of an optical signal between two microlens arrays. Embodiments described herein can also reduce the size of a PIC, which can reduce costs, and enable more PICs to be used per area on the interconnect to increase the area bandwidth density. Further details regarding 2D fiber array packaging for optical interfaces will now be described below with reference to FIGS. 1-14B.

FIG. 1A is a block diagram of system 100, according to some aspects of the disclosure, as shown, the system 100 can include optical signal source 101 and co-packaged device 103. Optical signal source 101 can provide, as input to co-packaged device, multiple wavelengths of optical signals (e.g., multiple wavelengths of light). For example, optical signal source 101 can include multiple optical signal generators (e.g., lasers) that each generate a respective wavelength of an optical signal. An example of co-packaged device 103 will now be described below with reference to FIGS. 1B-1C.

FIGS. 1B-1C are block diagrams of views of co-packaged device 103, according to some aspects of the disclosure. More specifically, FIG. 1B is a top-down view of co-packaged device 103, and FIG. 1C is a side view of co-packaged device 103.

As shown in FIG. 1B, co-packaged device 103 can include printed circuit board (PCB) 102, base interconnect 105 (e.g., an interposer), at least one processing unit and/or switch (PU/switch) 110 disposed on base interconnect 105, at least one network interface card (NIC) 120 disposed on base interconnect 105, serializer-deserializer (SERDES) 130 disposed on base interconnect 105, multiple interconnects 140-1 through 140-3 disposed on base interconnect 105, multiple photonic integrated circuits (PICs) 150 disposed on each of interconnects 140-1 through 140-3, and multiple waveguides 160-1 through 160-3 each coupled to a respective one of interconnects 140-1 through 140-3. In some embodiments, and as shown, the number of interconnects is three. However, the number of interconnects should not be considered limiting. In some embodiments, and as shown, each set of PICs includes four PICs 150. However, the number of PICs should not be considered limiting.

More specifically, each of interconnects 140-1 through 140-3 can be disposed between respective sets of PICs 150 and base interconnect 105. For example, as further shown in FIG. 1C, bumps 170 are disposed between PU/Switch 110 and base interconnect 105, and between PICs 150 and interconnects 140-1 through 140-3. Conductive wires 180 can be formed through the base interconnect 105 and the interconnects 140-1 through 140-3 to enable electrical connections between components of co-packaged device 103 (e.g., PU/switch 110 and PICs 150). Additionally, through each of interconnects 140-1 through 140-3, a respective waveguide system can be formed to provide optical signals to the PICs 150.

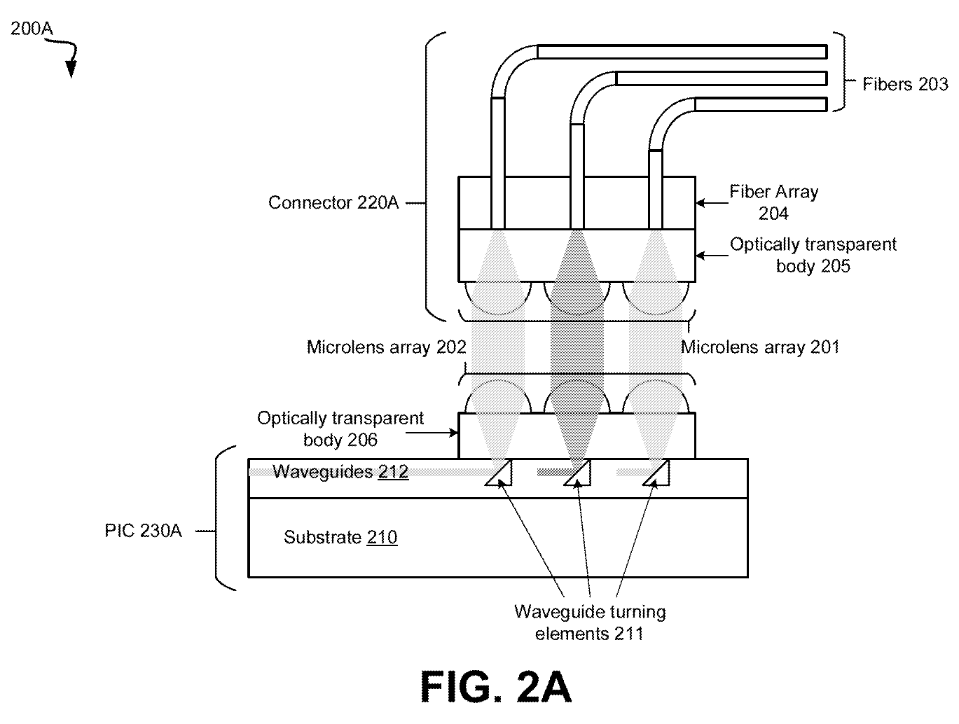

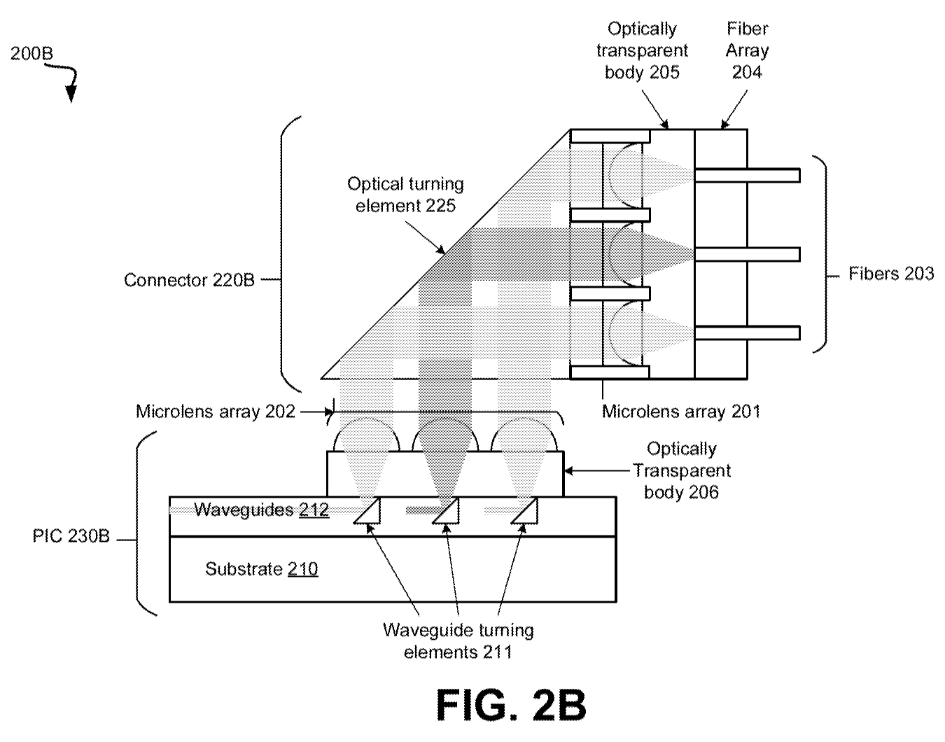

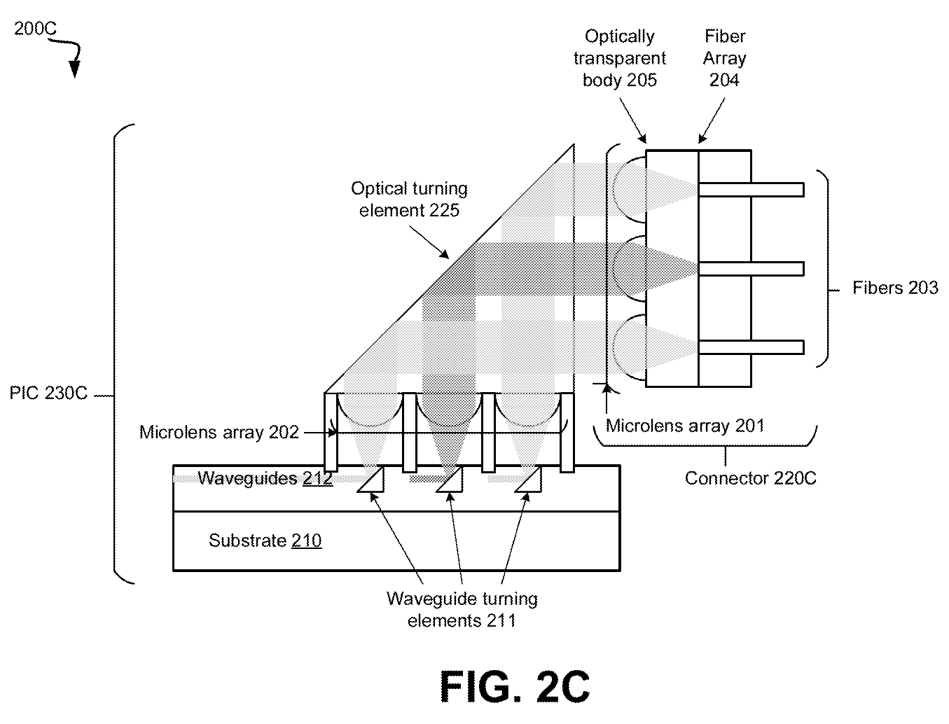

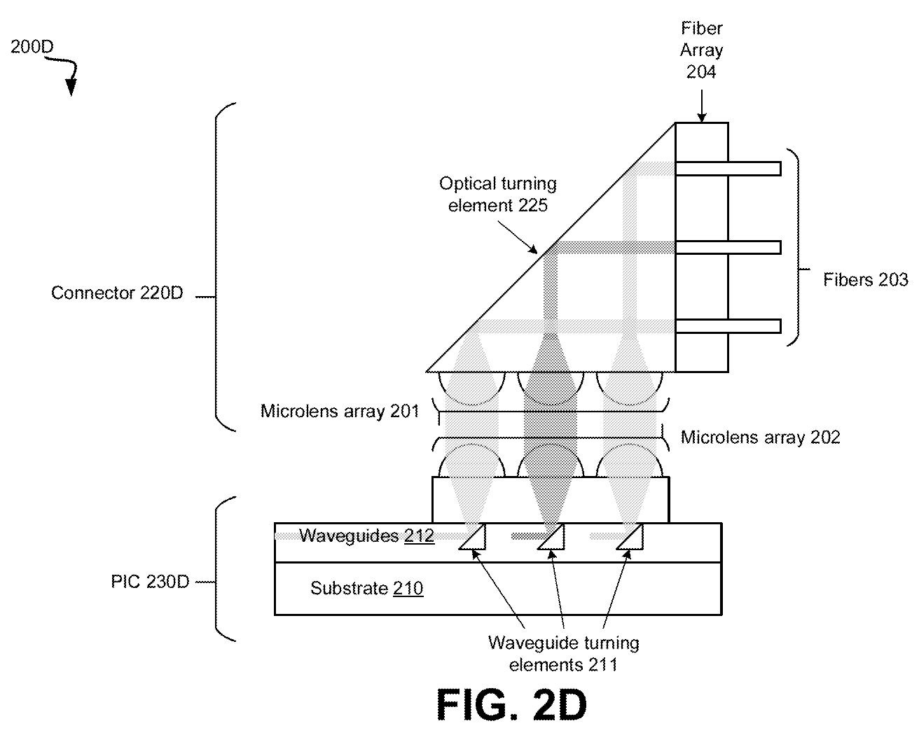

FIG. 2A is a block diagram of a side-view of an example system 200A, according to some aspects of the disclosure. The example system 200A includes an optical connector 220A that removably couples to a photonic integrated circuit (PIC) 230A.

The optical connector 220A includes fibers 203. In the illustrated example, the fibers 203 are bent at approximately a 90 degree angle. The fibers 203 can be bent at other angles ranging from approximately 10 degrees through approximately 170 degrees. In some embodiments, the fibers 203 are not bent and extend out perpendicular to the PIC 230A (e.g., where first ends of the fibers 203 in the fiber array 204 are approximately 180 degrees rotated with respect to second ends of the fibers 203). The fibers 203 are threaded through holes in a glass, ceramic, or similar material in a grid-like pattern to create fiber array 204. The ends of each fiber (e.g., each optical fiber core, also referred to herein as “optical core”) terminate at the edge of the fiber array 204, as illustrated. The fiber array 204 is bonded to an optically transparent body 205. In some embodiments, each fiber in the fiber array 204 is optically bonded to the optically transparent body 205. A microlens array 201 is optically and/or physically coupled to the optically transparent body 205.

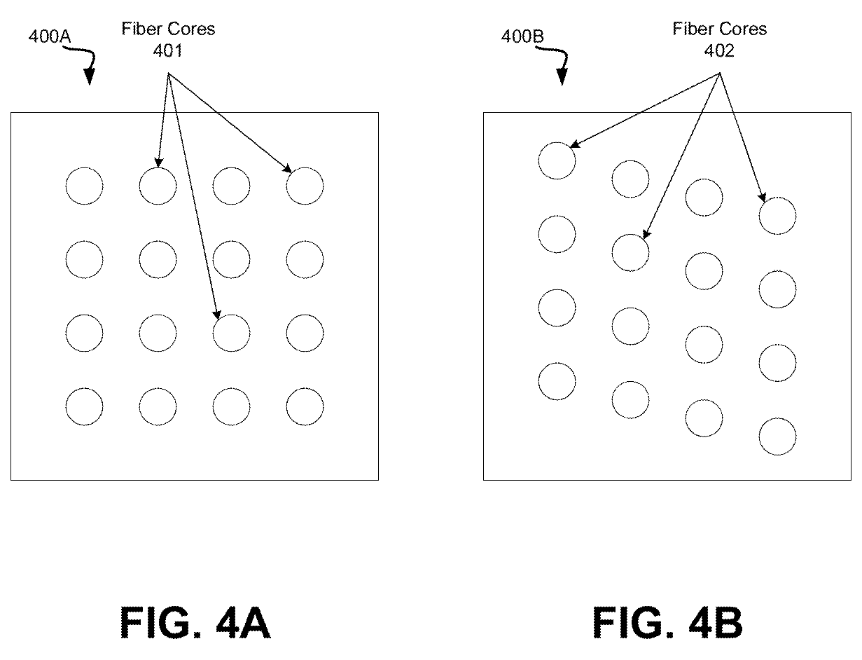

In some embodiments, the fiber array 204 is manufactured with each terminating optical fiber in a respective hole to form a grid-like pattern (as illustrated below in FIGS. 4A-B ). Once the fiber array 204 has been manufactured, the center of each fiber core is identified. There may be slight deviation in the alignment of one or more of the fiber cores relative to the holes in the optically transparent body, and relative to one another. These slight deviations can degrade an optical coupling performance in some situations. The microlens array 201 may be manufactured on the optically transparent body 205, based on the identified center of each fiber core. In this way, manufacturing and placement tolerance errors that may potentially result from manufacturing the fiber array separately from the microlens array can be reduced. That is, instead of presuming that the fiber cores in the fiber array will be at positions (X_{X}, Y_{Y}) and manufacturing a microlens array 201 with microlenses at positions (X_{X}, Y_{Y}), the actual positions of each fiber core can be determined to be (X₁, Y₁), (X₂, Y₂), etc. and the microlenses can be manufactured with positions of (X₁, Y₁), (X₂, Y₂) and so forth. In such embodiments, this may result in a slightly offset or skewed grid-like pattern of microlenses. However, due to the position of the microlenses being based on the position of the fiber cores in the fiber array, the slightly offset or skewed grid-like pattern of microlenses should closely match an offset or skewed grid-like pattern of fiber cores (of the fibers 203) in the fiber array 204. By ensuring that each microlens is aligned with a fiber core of a respective fiber, the ability of the microlens to focus a light beam is improved, resulting in improvements to optical coupling. In some embodiments, the microlens array 201 can be manufactured using manufacturing techniques such as three-dimensional (3D) microprinting, and/or 3D lithography.

In some embodiments, the optical connector 220A is configured to edge couple to the PIC 230A. The PIC 230A can be the same as or similar to the PICs 150 and accompanying structures as described in FIGS. 1A-C in some embodiments. The PIC 230A includes a microlens array 202 that is coupled to an optically transparent body 206. The PIC includes waveguides 212 and waveguide turning elements 211 that are configured to transmit optical signals up through the optically transparent body 206 and microlens array 202 during operation of the PIC 230A. The waveguides 212 sit in a substrate layer above the substrate 210 of the PIC 230A. In some embodiments, the waveguide turning elements can be arranged in a 2D array that corresponds to one or more of the microlens array 201 or the microlens array 202.

In some embodiments, the microlens array 202 can be manufactured based on the positions of the microlenses in the microlens array 201. That is, the microlens array 201 and the microlens array 202 can be manufactured as a pair of complimentary microlens arrays. This can further reduce alignment or manufacturing tolerance errors that impact the quality of the optical signals transmitted between the optical connector 220A and the PIC 230A. Thus, in some embodiments, a connector and a PIC can be manufactured as a coupled pair, in that maximum optical transmission between the PIC 230A and the optical connector 220A is achieved when a PIC 230A is paired with a matched optical connector 220A (e.g., with the same spacing between individual microlenses of microlens array 202 and corresponding individual microlenses of microlens array 201). In some embodiments, a PIC 230A that is paired with a non-matched optical connector 220A can still transmit functional optical signals, albeit with more loss in comparison to a matched optical connector 220A. In some embodiments, the microlens array 202 can be manufactured based on positions of the waveguide turning elements 211.

In some embodiments, the optical connector 220A is configured to removably couple to the PIC 230A. In some embodiments, the PIC 230A includes an optical port (not illustrated) to facilitate a mechanical connection between the optical connector 220A and the PIC 230A. In some embodiments, the mechanical connection between the optical connector 220A and the PIC 230A (e.g., an optical port or similar) can include or be similar to the mechanical connections used in one or more of a multi-fiber push-on (MPO) or multi-fiber termination push-on (MPT), a ribbon fiber connector, an array fiber connector, an optical backplane connector, an expanded beam connector, a hermaphroditic multi-fiber connector, or the like.

FIG. 2B is a block diagram of a side-view of an example system 200B, according to some aspects of the disclosure. The example system 200B includes an optical connector 220B that removably couples to a PIC 230B. The PIC 230B can be the same as or similar to the PICs 150 and accompanying structures described in FIGS. 1A-C , above, and/or the same as or similar to the PIC 230A described with reference to FIG. 2A.

The optical connector 220B includes fibers 203. In the illustrated example of system 200B, the fibers 203 are not bent. However, in alternative embodiments the fibers 203 in the optical connector 220B may be bent (not illustrated). The fibers 203 are threaded through holes in a glass, ceramic, or similar material in a grid-like pattern to create fiber array 204. The ends of each fiber (e.g., each optical core) terminate at the edge of the fiber array 204, as illustrated. The fiber array 204 is bonded to an optically transparent body 205. In some embodiments, each fiber in the fiber array 204 is optically bonded to the optically transparent body 205. A microlens array 201 is coupled to the optically transparent body 205. The microlens array 201 can be manufactured (e.g., 3D printed, etched, machined) onto the optically transparent body 205 based on the positions of the fiber cores of the fibers 203 in the fiber array 204, as described above with reference to FIG. 2A.

The optical connector 220B can include an optical turning element 225 that is mechanically affixed to the optically transparent body 205. In some embodiments (as illustrated), light barriers can be placed in between each microlens of the microlens array 201 to reduce the light transmission from adjacent microlenses.

In some embodiments during operation optical signals can enter from the fibers 203 in the fiber array 204 and pass through the optically transparent body 205 to the microlens array 201. The microlens array 201 can be configured to collimate optical signals from the fibers 203. The collimated optical signals pass into the optical turning element 225, which causes each respective optical signal to turn approximately 90 degrees. The turned optical signals can be output from the optical connector 220B into the microlens array 202 of the PIC 230B. The microlens array 202 couples the turned optical signals into the waveguide turning elements 211 of the PIC 230B, which couples the received optical signals into the waveguides 212.

In some embodiments, during operation optical signals can enter from the waveguides 212. The waveguides 212 couple the optical signals into the waveguide turning elements 211, which turn the optical signals approximately 90 degrees up through the optically transparent body 206 and out of the microlens array 202 into the optical connector 220B. The optical turning element 225 can turn the optical signals (originating from the waveguides 212) by approximately 90 degrees. These light signals can be aligned such that the microlens array 201 focuses the optical signals into respective optical cores of the fibers 203 of the fiber array 204.

In some embodiments, the optical turning element 225 is a passive optical component and can include one or more of a flat or curved mirror, a prism, a beam splitter, or diffraction grating. As illustrated in the system 200B, the optical turning element 225 is mechanically affixed to the connector 220B. In alternative embodiments, the optical turning element 225 can be mechanically affixed to the PIC 230B (such as in FIG. 2C, described below).

FIG. 2C is a block diagram of a side-view of an example system 200C, according to some aspects of the disclosure. The example system 200C includes a optical connector 220C that removably couples to a PIC 230C. The PIC 230C can be the same as or similar to the PICs 150 and accompanying structures described in FIGS. 1A-C above, and/or the same as or similar to the PIC 230A described with reference to FIG. 2A.

The optical connector 220C includes fibers 203. In the illustrated example of system 200C, the fibers 203 are not bent, however in alternative embodiments the fibers 203 in the optical connector 220C may be bent (not illustrated). The fibers 203 are threaded through holes in a glass, ceramic, or similar material in a grid-like pattern to create fiber array 204. The ends of each fiber (e.g., each optical core) terminate at the edge of the fiber array 204, as illustrated. The fiber array 204 is bonded to an optically transparent body 205. In some embodiments, each fiber in the fiber array 204 is optically bonded to the optically transparent body 205. A microlens array 201 is optically coupled to the optically transparent body 205. The microlens array 201 can be manufactured onto the optically transparent body 205 based on the positions of the fiber cores of the fibers 203 in the fiber array 204, as described above with reference to FIG. 2A.

The PIC 230C can include an optical turning element 225 that is mechanically affixed to the portion of the substrate that contains the waveguides 212. In some embodiments (as illustrated), light barriers can be placed in between each microlens of the microlens array 202 to reduce the light transmission from adjacent microlenses.

In some embodiments during operation optical signals can enter from the fibers 203 in the fiber array 204 and pass through the optically transparent body 205 to the microlens array 201. The microlens array 201 can be configured to collimate optical signals from the fibers 203. These collimated optical signals are output from the optical connector 220C to the PIC 230C. The collimated optical signals enter the PIC 230C at the optical turning element 225, which causes each respective optical signal to turn approximately 90 degrees. The turned optical signals can be focused by the microlens array 202 of the PIC 230C onto the waveguide turning elements 211. The waveguide turning elements 211 of the PIC 230C couples the optical signals into the waveguides 212.

In some embodiments during operation optical signals can enter from the waveguides 212. The waveguides 212 couple the optical signals into the waveguide turning elements 211, which turn the optical signals approximately 90 degrees up through the optically transparent body 206 and out of the microlens array 202 into the optical turning element 225. The optical turning element 225 can turn the optical signals (originating from the waveguides 212) by approximately 90 degrees. These turned optical signals are output from the PIC 230C to the optical connector 220C. The turned optical signals can be aligned at the output from the PIC 230C (e.g., the output of the optical turning element 225) such that the microlens array 201 focuses the optical signals into respective optical cores of the fibers 203 of the fiber array 204 of the optical connector 220C.

FIG. 2D is a block diagram of a side-view of an example system 200D, according to some aspects of the disclosure. The example system 200D includes a optical connector 220D that removably couples to a PIC 230D. The PIC 230D can be the same as or similar to the PICs 150 and accompanying structures described in FIGS. 1A-C , above, and/or the same as or similar to the PIC 230A described with reference to FIG. 2A.

The optical connector 220D includes fibers 203. In the illustrated example system 200D, the fibers 203 are not bent, however in alternative embodiments the fibers 203 in the optical connector 220D may be bent (not illustrated). The fibers 203 are threaded through holes in a glass, ceramic, or similar material in a grid-like pattern to create fiber array 204. The ends of each fiber (e.g., each optical core) terminate at the edge of the fiber array 204, as illustrated. The fiber array 204 is bonded to an optical turning element 225. The optical turning element 225 can include one or more optical interfaces. As used herein, “optical interface” can refer to a surface of the optical turning element 225 through which optical signals are configured to pass. In the illustrated example, the optical turning element 225 includes two optical interfaces, where the first optical interface is bonded to the fiber array 204 and the second optical interface is bonded to the microlens array 201.

In some embodiments, the microlens array 201 is manufactured on the optical turning element 225, as is similarly described above with reference to FIG. 2A. Once the fiber array 204 has been manufactured, the optical turning element 225 can be bonded to the fiber array 204. The center of each optical signal (e.g., originating from the fiber core of fibers 203) can be identified. Based on the projected center of each optical signal on the second optical interface of the optical turning element 225, the positions of each corresponding microlens in the microlens array 201 can be determined. That is, each microlens can be manufactured such that the center of each microlens is based on the projected center of each optical signal as identified at the output of the optical connector 220D (e.g., the second optical interface of the optical turning element 225).

The PIC 230D can be the same as or similar to the PIC 230A as described with reference to FIG. 2A.

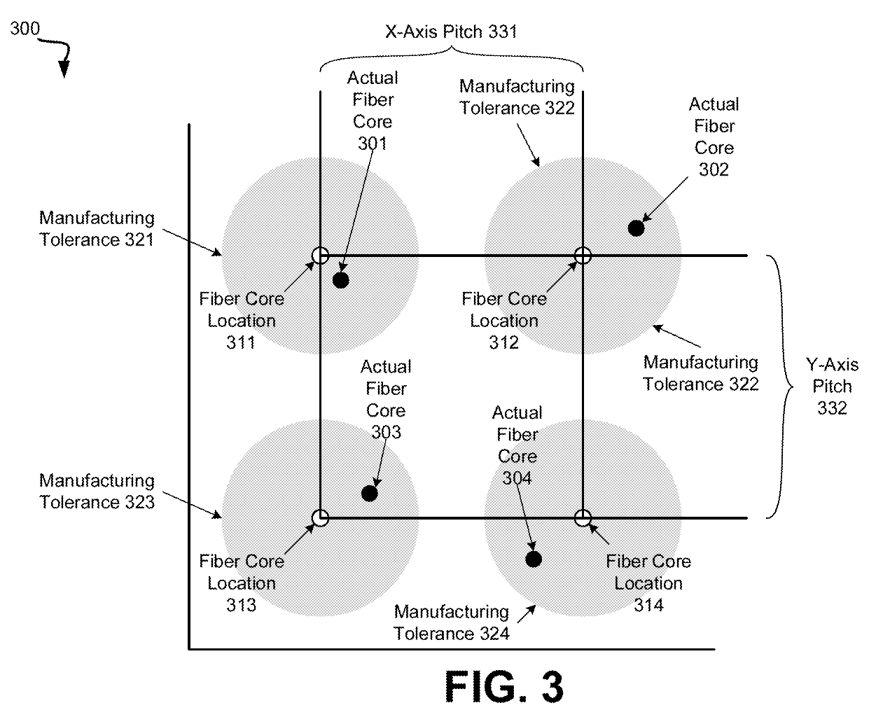

FIG. 3 is an illustration of a portion of fiber array 300, according to some aspects of the disclosure. The fiber array 300 illustrates actual fiber cores 301, 302, 303, 304, (e.g., a first, second, third, and fourth fiber core, illustratively) having fiber core locations 311, 312, 313, 314, (e.g., a first, second, third, and fourth fiber core design locations, illustratively) aligned with the x-axis pitch 331 (e.g., x-direction pitch) and y-axis pitch 332 (e.g., y-direction pitch) and manufacturing tolerances 321, 322, 323, 324 for each fiber core location 311, 312, 313, 314.

The fiber core locations 311, 312, 313, 314 are centered at the intersection of the gridlines that illustrate the x-axis pitch 331 and y-axis pitch 332. These are the designed locations for each fiber core (e.g., the intended location for each fiber core). However, due to the size of the features being manufactured, the tolerance for the location of the center of the fiber core can be relatively large. This large manufacturing tolerance can result in fiber cores in a fiber array such as fiber array 300 of FIGS. 2A-2D being shifted significantly from their designed locations, resulting in a reduced performance or failure of optical signal transmission.

Additionally, when a microlens array is manufactured, similar manufacturing tolerances can cause the centers of each microlens to deviate from a designed position. Thus, when the manufacturing errors for the fiber cores and the manufacturing errors for the microlenses stack, the total deviation may be doubled. That is, when an array of fiber cores are bonded to an array of microlenses such that a respective fiber core of the array of fiber cores is to be optically aligned with a respective microlens of the array of microlenses, the deviation of the fiber cores in the array of fiber cores and the separate deviation of the microlenses in the array of microlenses can add together to create a potential deviation between the center of a respective fiber core and corresponding microlens as large as approximately 1-2 µm.

As described herein, the errors due to manufacturing tolerances can be reduced by identifying the location of the actual fiber core 301, 302, 303, 304 in a fiber array such as fiber array 300 of FIGS. 2A-D and using the location of the actual fiber core 301, 302, 303, 304 as an indication for where to manufacture the microlenses of the microlens array (e.g., such as the microlens array 201 of FIGS. 2A-D ). By relying on the location of the actual fiber core 301, 302, 303, 304 as a basis for the center of microlenses in a microlens array instead of the designed fiber core locations 311, 312, 313, 314, the fiber cores in a fiber array will align more closely with the microlenses in a corresponding microlens array.

As described above, once the locations of the actual fiber cores 301, 302, 303, 304 are identified in a fiber array, the microlenses can be manufactured on the surface of an optically transparent material (optionally including an optical turning element). The microlenses can be manufactured using manufacturing techniques such as 3D microprinting, 3D lithography, or the like. In some embodiments, the locations of the actual fiber cores 301, 302, 303, 304 can be determined using image analysis. For example and in some embodiments, a machine vision camera can be used to identify the locations of the actual fiber cores 301, 302, 303, 304.

In some embodiments, the diameter of a single mode fiber (SMF) core can be approximately 8-10 µm without cladding, and 120-130 µm with cladding. The x-axis pitch 331 of the fiber array and the y-axis pitch 332 of the fiber array can be limited by the diameter of the fiber core with cladding. For example, and in some embodiments, the distance illustrated as the x-axis fiber pitch 331 in FIG. 3 and the y-axis pitch 332 can have a lower boundary of 120-130 µm to account for the cladding of each fiber core in the fiber array 300.

FIG. 4A is an example fiber array 400A, according to some aspects of the disclosure. The example fiber array 400A illustrates the fiber array 400A having an aligned pitch, where each fiber core 401 is designed to align along a standard right-angled grid-like pattern, as illustrated.

FIG. 4B is an example fiber array 400B, according to some aspects of the disclosure. The example fiber array 400B illustrates the fiber array 400B having a staggered pitch, where each fiber core 402 is designed to sit along a skewed grid-like pattern, as illustrated.

The embodiments described herein can be designed to function at least with the fiber cores 401, 402 having the aligned pitch of fiber array 400A or the staggered pitch of fiber array 400B. It can be appreciated that the aligned pitch and staggered pitch are illustrative and that embodiments described herein are not limited to these pitches, but can be adapted to other fiber pitches that may exist now or in the future.

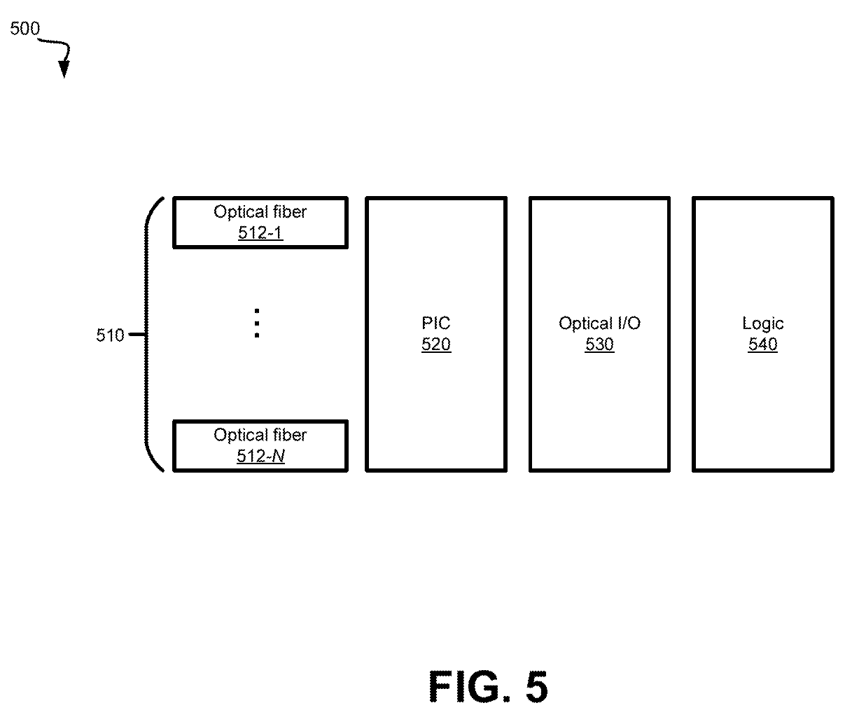

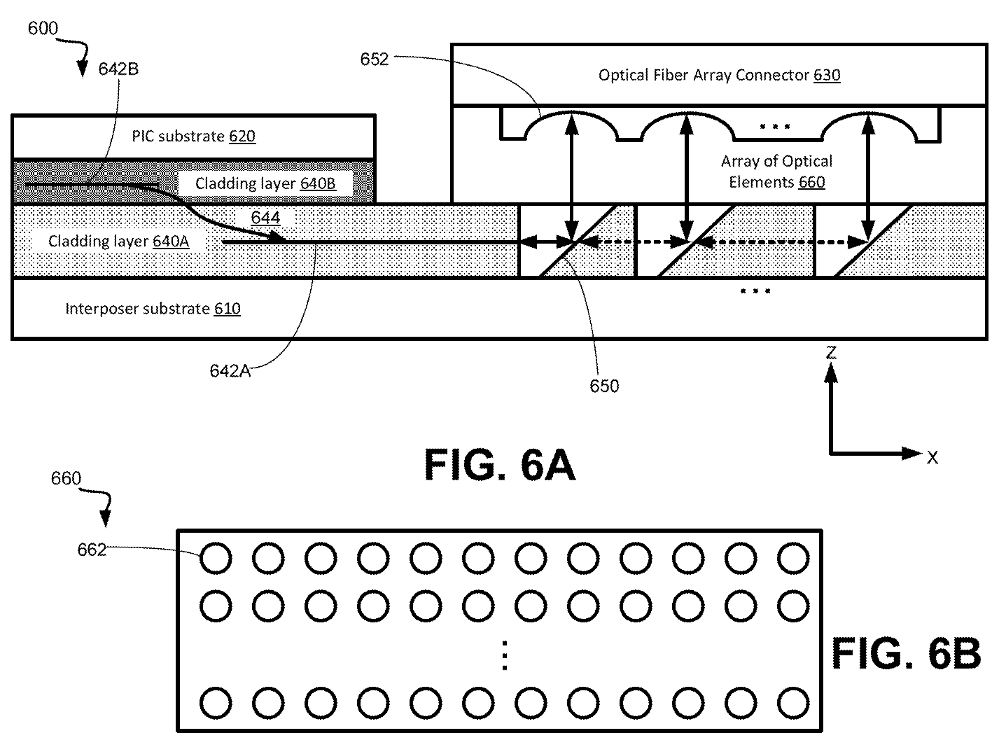

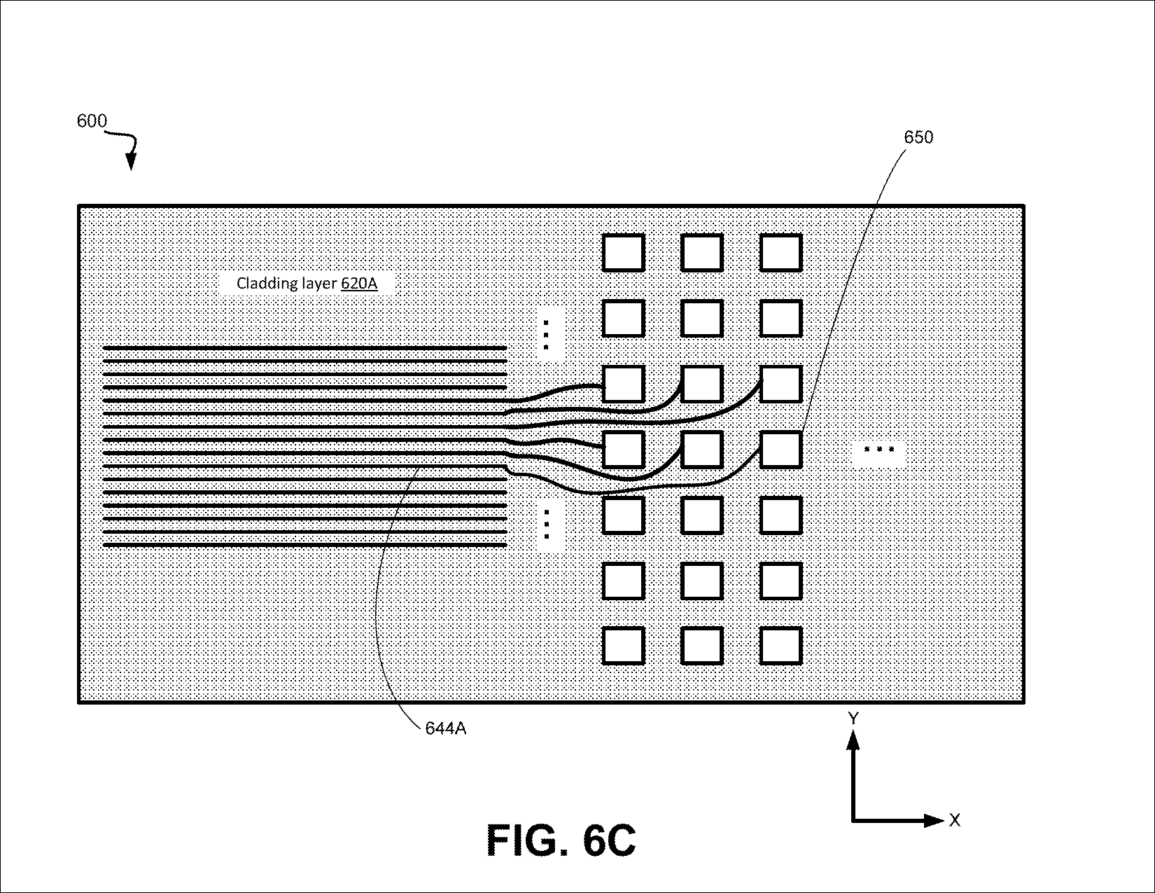

FIG. 5 is a block diagram of a top-down view of an example system 500, according to some aspects of the disclosure. As shown, the system 500 can include an optical fiber array 510 including N optical fibers 512-1 through 512-N. The system 500 can further include at least one PIC 520, optical I/O 530 and logic 540. The system 500 can correspond to an AI cluster architecture in some embodiments. As described above, the expected electrical bandwidth density (e.g., electrical “shoreline” bandwidth density) associated with the logic 540 may exceed 10 Tb/s/mm. As will now be described below with reference to FIGS. 6A-6C, an optical interface between a PIC and an optical fiber array can be used to achieve optical bandwidth densities that are greater than or equal to about 10 Tb/s/mm to match electrical bandwidth densities.

FIG. 6A is a diagram of cross-sectional view of an example system 600, according to some aspects of the disclosure. As shown in FIG. 6A, the system 600 can include an interposer substrate 610 of an interposer, a PIC substrate 620 of a PIC, and an optical fiber array connector 630 associated with an optical fiber array (e.g., the optical fiber array 510 of FIG. 5). The interposer substrate 610 and the PIC substrate 620 can be formed from any suitable material. In some embodiments, at least one of the interposer substrate 610 or the PIC substrate 620 is a silicon (Si) substrate.

FIG. 6B is a diagram of a bottom-up view of an example optical fiber array connector 660, according to some aspects of the disclosure. As shown in FIG. 6B, the optical fiber array connector 660 includes multiple channels 662 arranged in rows. In this illustrative embodiment, each row includes 12 channels. In some embodiments, there are 6 rows that each include 12 channels (i.e., 72 channels). However, the number of channels, rows of channels and/or number of channels within each row should not be considered limiting.

Referring back to FIG. 6A, the system 600 can further include an optical interface, formed on the interposer substrate 610, between the PIC substrate 620 and the optical fiber array connector 630. The optical interface can include a cladding layer 640A formed on the interposer substrate. The cladding layer 640A can include any suitable dielectric material. In some embodiments, the cladding layer 640A is formed from an oxide material. For example, the cladding layer 640A can be formed from SiO₂. More specifically, the cladding layer 640A can be a thick cladding layer. The cladding layer 640A can have any suitable thickness. In some embodiments, the thickness of the cladding layer 640A ranges from about 5 µm to about 20 µm.

The cladding layer 640A can include multiple (e.g., an array of) small trenches. For example, a trench can be a micro-trench. Each trench of the cladding layer 640A can have a turning element 650 formed therein. Each turning element 650 may include a reflective material (e.g., metal reflector) formed within a respective trench of the cladding layer 640A (e.g., formed on an angled trench wall of a respective trench). In some embodiments, the turning element 650 is a mirror. For example, the turning element 650 can be an angled mirror formed along an angled sidewall of its corresponding trench.

Multiple parallel inner cores, including inner core 642A, can be formed within the cladding layer 640A to form multiple parallel waveguides, and each turning element can be coupled (e.g., edge coupled) to a respective inner core of the multiple parallel inner cores (e.g., the turning element 650 coupled to the inner core 642A). The multiple parallel inner cores, including the inner core 642A, can be formed from any suitable material. The multiple parallel inner cores, including the inner core 642A, can have a higher refractive index than the cladding layer 640A to form effective optical waveguides. In some embodiments, the inner core 642A is formed from Si₃N₄.

FIG. 6C is a diagram of a top-down view of the system 600 showing example connections between the multiple inner cores including the inner core 644 and respective ones of the turning elements including the turning element 650, according to some aspects of the disclosure.

Referring back to FIG. 6A, the optical interface can further include an array of optical elements 660 formed on the thick cladding layer. The array of optical elements 660 can function as optical I/O to the optical fibers. For example, the array of optical elements 660 can collimate light to increase alignment tolerance. More specifically, each optical element of the array of optical elements 660 can direct and/or refocus light redirected by a respective turning element (e.g., reflected off a respective angled mirror) toward a respective optical fiber of an optical fiber array associated with the optical fiber array connector 630. The array of optical elements 660 can include any suitable optical elements and/or combinations of optical elements in accordance with embodiments described herein.

In some embodiments, the array of optical elements 660 is a 2D lens array. For example, the array of optical elements 660 can include one or more metalenses (e.g., an array of metalenses). A metalens is an ultra-thin, flat optical element that can focus or manipulate light. For example, a metalens can interact with light, altering its phase, amplitude, or polarization. By precisely controlling the shape, size, and arrangement of a metalens, the metalens can be designed to achieve various optical functions, such as focusing, beam shaping, creating holographic images, etc. Multiple metalenses can form a metalens array or stack on the backside of the PIC. A metalens can have sub-wavelength dimensions. In some embodiments, a metalens has a dimension that ranges from about 0.5 micrometer (µm) to about 2 µm. A metalens can be formed from any suitable material. The type of material can depend on a variety factors, such as target wavelength (visible light, infrared, etc.), efficiency, ease of fabrication, cost, etc. Examples of materials that can be used to form a metalens include silicon (Si), dielectric materials (e.g., titanium dioxide (TiO₂) and gallium nitride (GaN)), semiconductor materials (e.g., silicon nitride (SiN) and zinc selenide (ZnSe)), phase-change materials (e.g., germanium-antimony-tellurium (GST) and vanadium dioxide (VO₂)), transition metal dichalcogenides (e.g., molybdenum disulfide (MoS₂), tungsten disulfide (WS₂), tungsten diselenide (WSe₂), molybdenum ditelluride (MoTe₂), rhenium disulfide (ReS₂)), carbon (C) (e.g., graphene), metals (e.g., gold (Au) and silver (Ag)), etc.

As another example, the array of optical elements 660 can include one or more microlenses (e.g., an array of microlenses). A microlens can have a sphere or hemisphere shape that can function based on similar principles as a traditional curved lens. A microlens can have a diameter typically less than 1 mm. In some embodiments, a microlens has a diameter that ranges from about 100 µm to about 200 µm. The small size of microlenses can enable microlenses to focus light onto specific points. Microlenses can be formed from polymers, glass or other suitable optical materials. The type of material can depend on a variety factors, such as target wavelength (visible light, infrared, etc.), application (imaging, sensing, light coupling, etc.) efficiency, ease of fabrication, cost, etc. Examples of polymers that can be used to form a microlens include polymethl methacrylate (PMMA), polycarbonate (PC), epoxy, etc. Examples of glasses that can be used to form a microlens include Si, fused silica (SiO₂), chalcogenide glass, other optical glasses, etc.

In some embodiments, and as shown in FIG. 6A, an additional cladding layer 640B is formed on the cladding layer 640A. The additional cladding layer 640B can include any suitable dielectric material. In some embodiments, the additional cladding layer 640B is formed from an oxide material. For example, the additional cladding layer 640B can be formed from SiO₂. The additional cladding layer 640B can have a smaller thickness than the cladding layer 640A.

Multiple inner cores (e.g., tapered inner cores) (e.g., inner core 642B) can be formed within the additional cladding layer 640B to form multiple waveguides (e.g., tapered waveguides). Each of the inner cores formed within the cladding layer 640B can be configured to enable evanescent wave coupling of an optical signal with respect to a respective inner core formed within the cladding layer 640A (e.g., evanescent wave coupling between the inner core 642A and the inner core 642B, as indicated by the arrow to the inner core 644). The inner core 642B can be formed from any suitable material. The material of the inner core 642B can have a higher refractive index than the additional cladding layer 640B to form an effective optical waveguide. In some embodiments, the inner core 642B is formed from Si₃N₄.

In some embodiments, the cladding layer 640B is hybrid bonded to the cladding layer 640A. Hybrid bonding refers to an advanced chip integration technique that combines both electrical and mechanical bonding at the wafer or die level. Hybrid bonding can allow for two components (e.g., wafers and/or chips) to be directly connected to each other by creating nanoscale interconnections, which can enable higher density, better performance, and lower power consumption as compared to traditional bonding techniques such as wire bonding, flip-chip bonding, etc.

In some embodiments, the minimum pitch of turning elements (e.g., in the vertical direction when viewing the interposer from a top-down view) can be determined based at least in part on a minimum optical fiber pitch. The number of columns of turning elements (e.g., in the horizontal direction when viewing the interposer from a top-down view) can be determined based at least in part by a minimum mirror width (e.g., process-defined), and the maximum optical waveguide density that can be routed between turning elements. Illustratively, for a 1D array of waveguides within the thick cladding layer, a 10 µm waveguide pitch within the thick cladding layer can be considered safe. For example, “safe” refers to the minimum safe distance between optical waveguides that ensures no unwanted optical coupling between adjacent waveguides. If the spacing were reduced below 10 µm, then there is greater probability for optical crosstalk between adjacent waveguides. Such a pitch can limit the maximum number of columns of turning elements to 11. Assuming a 127 µm pitch for the turning elements, a 200 gigabit/lane bandwidth, 11 columns of turning elements, and 7 turning elements per column within a 1 mm interposer shoreline, the maximum optical bandwidth density that can be achieved using the optical interface can be approximately 15.4 Tb/s/mm. Accordingly, optical interfaces described herein can achieve optical bandwidth densities that are greater than or equal to about 10 Tb/s/mm to match electrical bandwidth densities Accordingly, the optical interface shown in FIGS. 6A and 6C can be used to achieve optical bandwidth densities that are greater than or equal to about 10 Tb/s/mm to match electrical bandwidth densities.

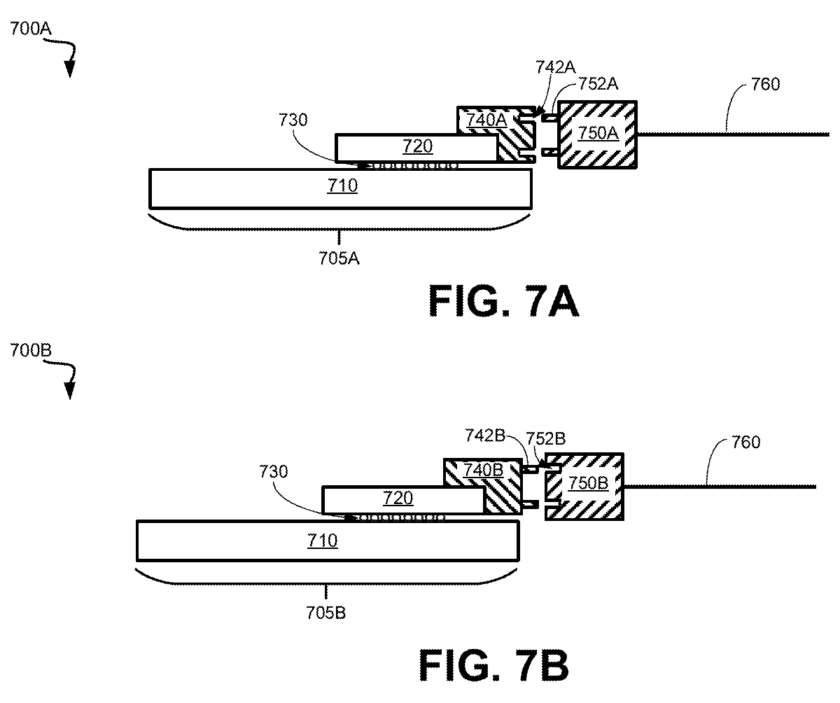

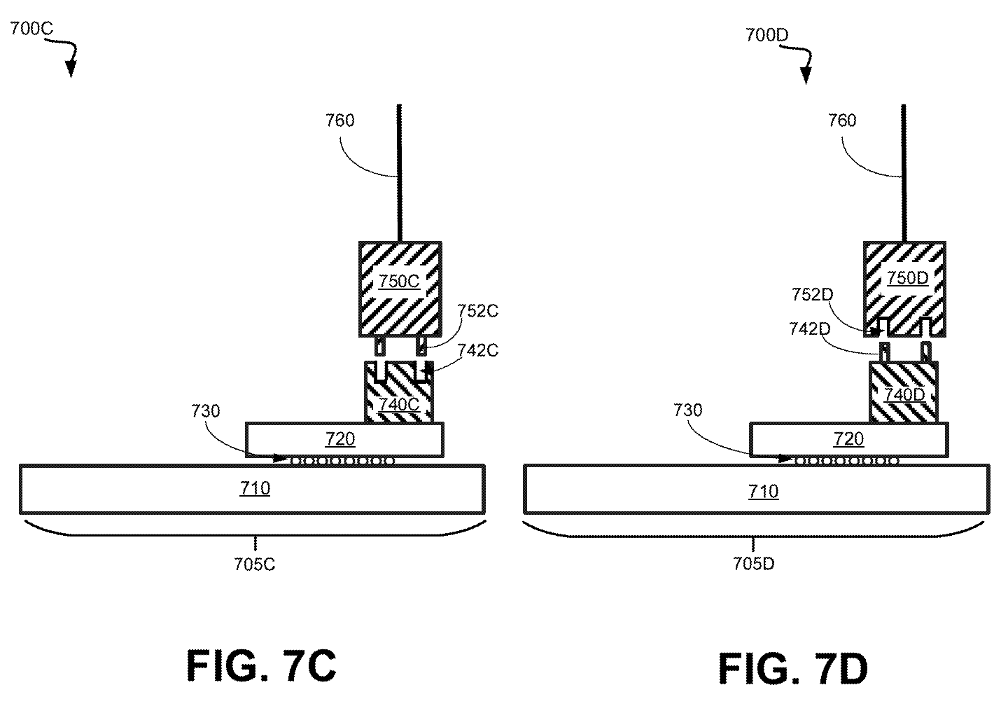

FIG. 7A is a diagram of system 700A, according to some aspects of the disclosure. As shown in FIG. 7A, system 700A can include device 705A including substrate 710, at least one photonic integrated circuit (PIC) 720, ball grid array 730 formed between substrate 710 and PIC 720, and connection component 740A integrated within device 705A. More specifically, connection component 740A is formed on PIC 720. System 700A further includes connection component 750A coupled to optical fiber 760.

In this illustrative example, connection component 740A is a female connection component having a set of openings including opening 742A. Connection component 750A is a male connection component having a set of protrusions including protrusion 752A. Each opening of the set of openings of connection component 740A is designed to receive a respective protrusion of the set of protrusions of connection component 750A. For example, opening 742A is designed to receive protrusion 752A.

System 700A enables optical fiber-to-waveguide coupling on a plane parallel to an upper surface of substrate 710 (e.g., horizontal coupling). For example, connection component 740A is attached to PIC 720 in a manner enables the connection component 750A to be received along the plane parallel to the upper surface of substrate 710.

FIG. 7B is a diagram of a device or system 700B, according to some aspects of the disclosure. As shown in FIG. 7B, system 700B can include device 705B including substrate 710, at least one PIC 720, ball grid array 730 formed between substrate 710 and PIC 720, and connection component 740B integrated within device 705B. More specifically, connection component 740B is formed on PIC 720. System 700B further includes connection component 750B coupled to optical fiber 760.

In this illustrative example, connection component 740B is a male connection component having a set of protrusions including protrusion 742B. Connection component 750B is a female connection component having a set of openings including opening 752B. Each opening of the set of openings of connection component 750B is designed to receive a respective protrusion of the set of protrusions of connection component 740B. For example, opening 752B is designed to receive protrusion 742B.

System 700B enables optical fiber-to-waveguide coupling on a plane parallel to an upper surface of substrate 710 (e.g., horizontal coupling). For example, connection component 740B is attached to PIC 720 in a manner enables the connection component 750B to be received along the plane parallel to the upper surface of substrate 710.

FIG. 7C is a diagram of a device or system 700C, according to some aspects of the disclosure. As shown in FIG. 7C, system 700C can include device 705C including substrate 710, at least one PIC 720, ball grid array 730 formed between substrate 710 and PIC 720, and connection component 740C integrated within device 705C. More specifically, connection component 740C is formed on PIC 720. System 700C further includes connection component 750C coupled to optical fiber 760.

In this illustrative example, connection component 740C is a female connection component having a set of openings including opening 742C. Connection component 750C is a male connection component having a set of protrusions including protrusion 752C. Each opening of the set of openings of connection component 740C is designed to receive a respective protrusion of the set of protrusions of connection component 750C. For example, opening 742C is designed to receive protrusion 752C.

System 700C enables optical fiber-to-waveguide coupling on a plane perpendicular to an upper surface of substrate 710 (e.g., vertical coupling). For example, connection component 740C is attached to PIC 720 in a manner enables the connection component 750C to be received along the plane perpendicular to the upper surface of substrate 710.

FIG. 7D is a diagram of a device or system 700D, according to some aspects of the disclosure. As shown in FIG. 7D, system 700D can include device 705D including substrate 710, at least one PIC 720, ball grid array 730 formed between substrate 710 and PIC 720, and connection component 740D integrated within device 705D. More specifically, connection component 740D is formed on PIC 720. System 700D further includes connection component 750D coupled to optical fiber 760.

In this illustrative example, connection component 740D is a male connection component having a set of protrusions including protrusion 742D. Connection component 750D is a female connection component having a set of openings including opening 752D. Each opening of the set of openings of connection component 750D is designed to receive a respective protrusion of the set of protrusions of connection component 740D. For example, opening 752D is designed to receive protrusion 742D.

System 700D enables optical fiber-to-waveguide coupling on a plane perpendicular to an upper surface of substrate 710 (e.g., horizontal coupling). For example, connection component 740D is attached to PIC 720 in a manner enables the connection component 750D to be received along the plane perpendicular to the upper surface of substrate 710.

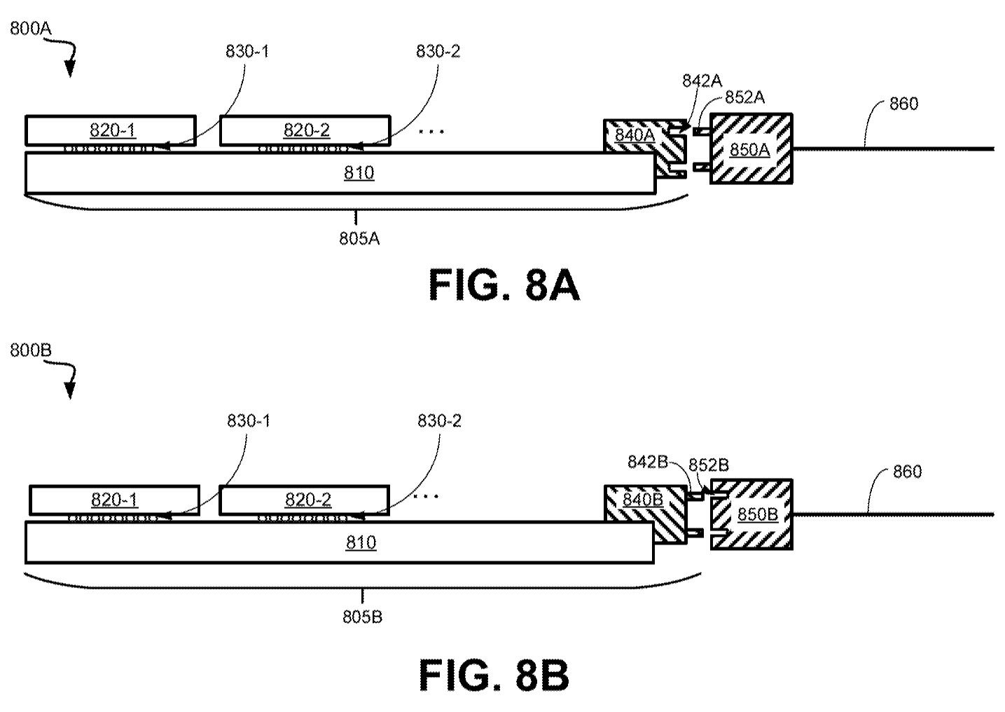

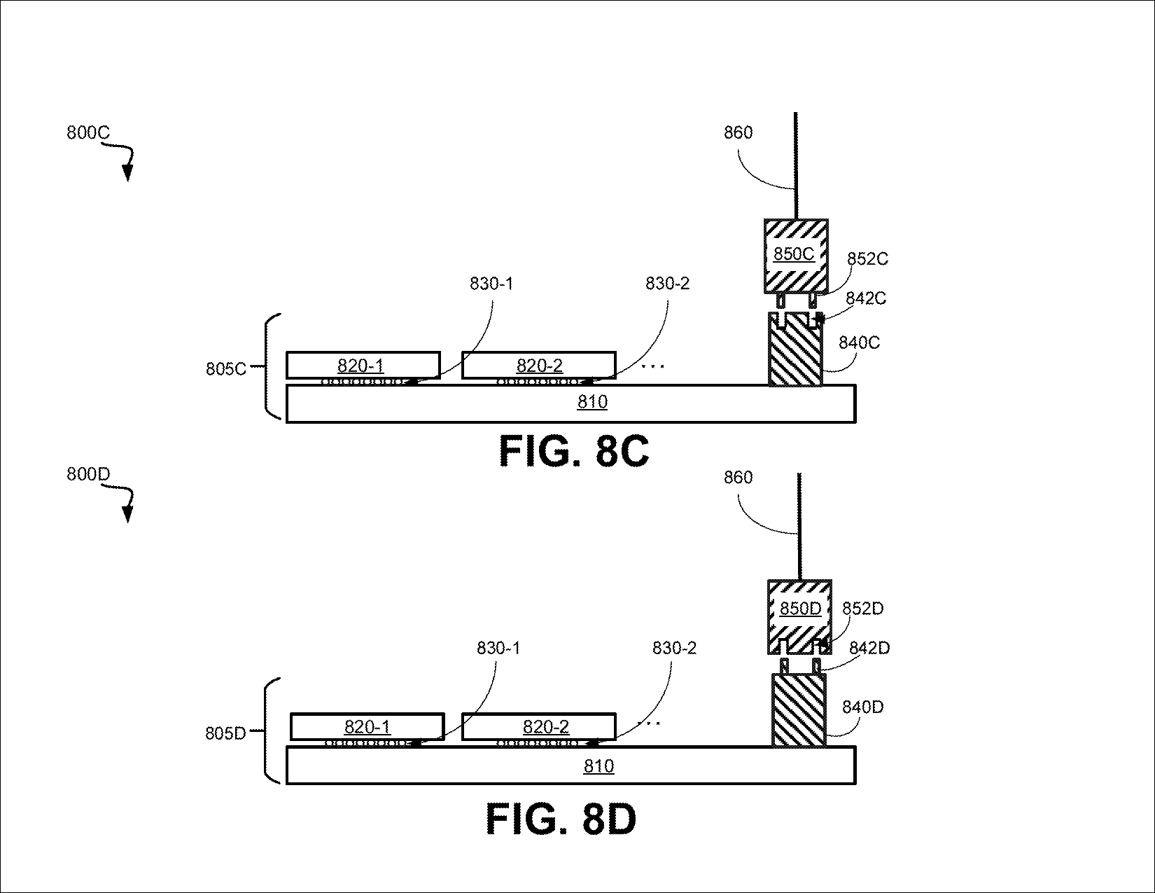

FIG. 8A is a diagram of a device or system 800A, according to some aspects of the disclosure. As shown in FIG. 8A, system 800A can include device 805A including substrate 810, multiple PICs including PIC 820-1 and 820-1, multiple ball grid arrays formed between substrate 810 and respective ones of the PICs, including ball grid array 830-1 formed between substrate 810 and PIC 820-1 and ball grid array 830-2 formed between substrate 810 and PIC 820-2, and connection component 840A integrated within device 805A. More specifically, connection component 840A is formed on substrate 810. System 800A further includes connection component 850A coupled to optical fiber 860.

In this illustrative example, connection component 840A is a female connection component having a set of openings including opening 842A. Connection component 850A is a male connection component having a set of protrusions including protrusion 852A. Each opening of the set of openings of connection component 840A is designed to receive a respective protrusion of the set of protrusions of connection component 850A. For example, opening 842A is designed to receive protrusion 852A.

Similar to system 700A, system 800A enables optical fiber-to-waveguide coupling on a plane parallel to an upper surface of substrate 810 (e.g., horizontal coupling). For example, connection component 840A is attached to substrate 810 in a manner enables the connection component 850A to be received along the plane parallel to the upper surface of substrate 810.

FIG. 8B is a diagram of a device or system 800B, according to some aspects of the disclosure. As shown in FIG. 8B, system 800B can include device 805B including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840B integrated within device 805B. More specifically, connection component 840B is formed on substrate 810. System 800B further includes connection component 850B coupled to optical fiber 860.

In this illustrative example, connection component 840B is a male connection component having a set of protrusions including protrusion 842B. Connection component 850B is a female connection component having a set of openings including opening 852B. Each opening of the set of openings of connection component 850B is designed to receive a respective protrusion of the set of protrusions of connection component 840B. For example, opening 852B is designed to receive protrusion 842B.

Similar to system 700B, system 800B enables optical fiber-to-waveguide coupling on a plane parallel to an upper surface of substrate 810 (e.g., horizontal coupling). For example, connection component 840B is attached to substrate 810 in a manner enables the connection component 850B to be received along the plane parallel to the upper surface of substrate 810.

FIG. 8C is a diagram of a device or system 800C, according to some aspects of the disclosure. As shown in FIG. 8C, system 800C can include device 805C including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840C integrated within device 805C. More specifically, connection component 840C is formed on substrate 810. System 800C further includes connection component 850C coupled to optical fiber 860.

In this illustrative example, connection component 840C is a female connection component having a set of openings including opening 842C. Connection component 850C is a male connection component having a set of protrusions including protrusion 852C. Each opening of the set of openings of connection component 840C is designed to receive a respective protrusion of the set of protrusions of connection component 850C. For example, opening 842C is designed to receive protrusion 852C.

Similar to system 700C, system 800C enables optical fiber-to-waveguide coupling on a plane perpendicular to an upper surface of substrate 810 (e.g., vertical coupling). For example, connection component 840C is attached to substrate 810 in a manner enables the connection component 850C to be received along the plane perpendicular to the upper surface of substrate 810.

FIG. 8D is a diagram of a device or system 800D, according to some aspects of the disclosure. As shown in FIG. 8D, system 800D can include device 805D including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840D integrated within device 805D. More specifically, connection component 840D is formed on substrate 810. System 800D further includes connection component 850D coupled to optical fiber 860.

In this illustrative example, connection component 840D is a male connection component having a set of protrusions including protrusion 842D. Connection component 850D is a female connection component having a set of openings including opening 852D. Each opening of the set of openings of connection component 850D is designed to receive a respective protrusion of the set of protrusions of connection component 840D. For example, opening 852D is designed to receive protrusion 842D.

System 800D enables optical fiber-to-waveguide coupling on a plane perpendicular to an upper surface of substrate 810 (e.g., horizontal coupling). For example, connection component 840D is attached to substrate 810 in a manner enables the connection component 850D to be received along the plane perpendicular to the upper surface of substrate 810.

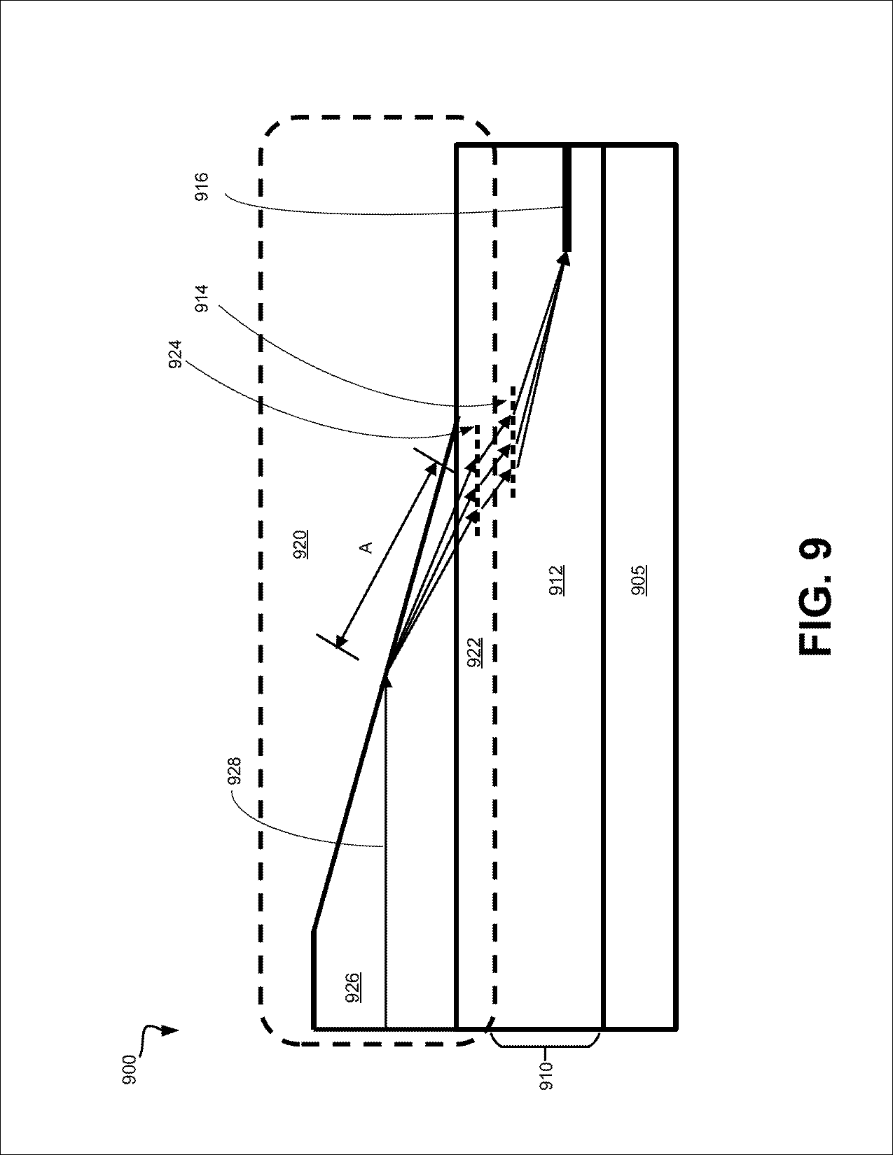

FIG. 9 is a diagram of a device or system 900, according to some aspects of the disclosure. As shown in FIG. 9, system 900 can include substrate 905 and connection component 910 formed on substrate 905. Connection component 910 can include first portion of a cladding layer (“cladding layer portion”) 912, first portion of a collimator assembly (“collimator assembly portion”) 914 formed in first portion of the cladding layer 912, and waveguide 916 formed in cladding layer portion 912. System 900 can further include connection component 920 corresponding to a detachable optical fiber component. Connection component 920 can include second portion of a cladding layer (“cladding layer portion”) 922, and second portion of the collimator assembly (“collimator assembly portion”) 924 formed in cladding layer portion 912. Connection component 920 can further include angle-cleaved optical fiber 926. The collimator assembly can increase the alignment tolerance of connection component 920. In some embodiments, collimator assembly portions 914 and 924 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 µm to about 100 µm.

Optical signals 928 can travel through angle-cleaved optical fiber 926, which can, upon incidence at the interface between angle-cleaved optical fiber 926 and the surrounding environment (e.g., air), be directed toward the collimator assembly. In some embodiments, distance “A” ranges between about 300 µm to about 500 µm. In some embodiments, distance “A” is about 400 µm. Optical signals 928 can pass through the collimator assembly and can be coupled to waveguide 916. Optical signals 928 can be coupled to waveguide 916 with a small angle (e.g., less than or equal to about 20 degrees) to have a low impact on coupling loss. This can eliminate the need for a grating coupler or mirror alignment and can have relatively low loss and large 1 dB bandwidth in wavelength.

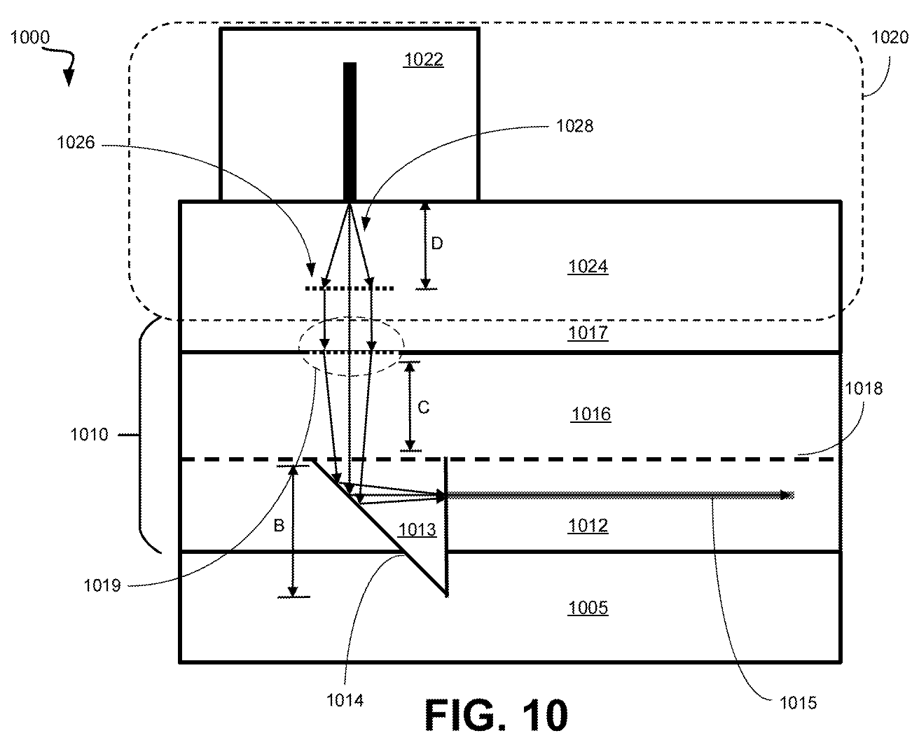

FIG. 10 is a diagram of a device or system 1000, according to some aspects of the disclosure. As shown in FIG. 10, system 1000 can include substrate 1005 and connection component 1010 formed on substrate 1005. Connection component 1010 can include cladding layer 1012 formed on substrate 1005, trench 1013 formed at least through cladding layer 1012, mirror 1014 formed (e.g., coated) on a sidewall of trench 1013, and waveguide 1015 formed within cladding layer 1012. Trench 1013 can have a triangular cross-sectional shape (e.g., right triangular cross-sectional shape), and mirror 1014 can be formed on an angled sidewall of trench 1013 (e.g., the sidewall corresponding to the hypotenuse of the right triangular cross-sectional shape). In some embodiments, trench 1013 is formed by using a dry etch process. Connection component 1010 can further include a stack including substrate 1016 and portion of a second cladding layer (“cladding layer portion”) 1017 formed on substrate 1016. Cladding layer 1012 and substrate 1016 can be bonded together by bonding layer 1018. A portion of a collimator assembly (“collimator assembly portion”) 1019 can be formed between substrate 1016 and cladding layer portion 1017.

System 1000 can further include connection component 1020 corresponding to a detachable optical fiber connector including cleaved optical fiber 1022 formed on portion of the second cladding layer (“cladding layer portion”) 1024, and portion of the collimator assembly (“collimator assembly portion”) 1026 formed within cladding layer portion 1024. The collimator assembly can increase the alignment tolerance of connection component 1020. In some embodiments, collimator assembly portions 1019 and 1026 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 µm to about 100 µm.

Optical signals 1028 can travel through cleaved optical fiber 1022, which can, upon incidence at the interface between cleaved optical fiber 1022 and cladding layer 1024, be directed toward the collimator assembly. The collimator assembly can then direct optical signals 1028 toward mirror 1014. Mirror 1014 can be designed to direct optical signals 1028 toward waveguide 1015. Optical signals 1028 can be coupled into waveguide 1015 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “B” ranges between about 10 µm to about 20 µm. In some embodiments, distance “B” is about 15 µm. In some embodiments, distance “C” ranges between about 600 µm to about 800 µm. In some embodiments, distance “C” is about 700 µm. In some embodiments, distance “D” ranges between about 600 µm to about 800 µm. In some embodiments, distance “D” is about 700 µm.

In some embodiments, the optical fiber 1022 is separated from the cladding layer portion 1024 by a gap. In some embodiments, the optical fiber 1022 is separated from the cladding layer portion 1024 by one or more layers.

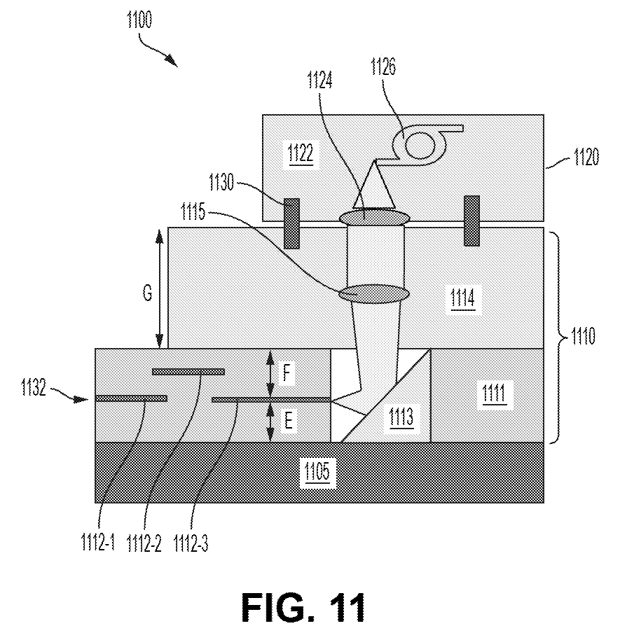

FIG. 11 is a diagram of a device or system 1100, according to some aspects of the disclosure. As shown in FIG. 11, system 1100 can include substrate 1105 and connection component 1110 formed on substrate 1105. Connection component 1110 can include cladding layer 1111, a set of waveguides include waveguides 1112-1 through 1112-3 formed within cladding layer 1111, and mirror 1113 formed within cladding layer 1111 and on substrate 1105. More specifically, mirror 1113 can be formed within a trench formed within cladding layer 1111. In some embodiments, mirror 1113 is an angled mirror having a triangular cross-sectional shape (e.g., right-triangular cross-sectional shape). Connection component 1110 can further include layer 1114 formed on cladding layer 1112, and a first portion of a collimator assembly (“collimator assembly portion”) 1115 formed in layer 1114.

System 1100 can further include connection component 1120 corresponding to a detachable optical fiber component. Connection component 1120 can include cladding layer 1122, second portion of the collimator assembly (“collimator assembly portion”) 1124 formed in cladding layer 1122, and optical fiber 1126 formed in cladding layer 1122. Connection component 1120 can be attached to connection component 1110 via connectors 1130. More specifically, connectors 1130 can enable connection component 1120 to be detached from connection component 1110.

The collimator assembly can increase the alignment tolerance of connection component 1130. In some embodiments, collimator assembly portions 1115 and 1124 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 µm to about 100 µm.

Optical signals 1132 can travel through the set of waveguides, which can, upon incidence upon mirror 1113, be directed toward the collimator assembly. Optical signals 1132 can pass through the collimator assembly and can be coupled to optical fiber 1126. Optical signals 1132 can be coupled to optical fiber 1126 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “E” corresponding to the distance between substrate 1105 and waveguide 1112-3 ranges between about 4 µm to about 8 µm. In some embodiments, distance “E” is about 5 µm. In some embodiments, distance “F” corresponding to the distance between layer 1114 and waveguide 1112-2 ranges between about 4 µm to about 8 µm. In some embodiments, distance “F” is about 5 µm. In some embodiments, width “G” corresponding to the width of layer 1114 ranges between about 100 µm to about 500 µm. In some embodiments, each lens has a diameter that ranges between about 30 µm to about 100 µm.

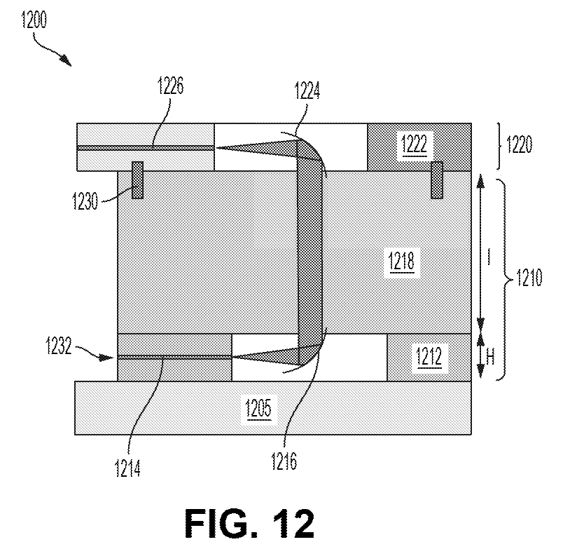

FIG. 12 is a diagram of a device or system 1200, according to some aspects of the disclosure. As shown in FIG. 12, system 1200 can include substrate 1205 and connection component 1210 formed on substrate 1205. Connection component 1210 can include cladding layer 1212, waveguide 1214 formed within cladding layer 1212, and mirror 1216 formed within cladding layer 1212. More specifically, mirror 1216 can be formed within a trench formed within cladding layer 1212. In some embodiments, mirror 1216 is a concave mirror. In some embodiments, connection component 1210 further includes spacer 1218 formed on cladding layer 1212.

System 1200 can further include connection component 1220 corresponding to a detachable optical fiber component. Connection component 1220 can include cladding layer 1222, mirror 1224 formed in cladding layer 1222, and optical fiber 1226 formed in cladding layer 1222. More specifically, mirror 1224 can be formed within a trench formed within cladding layer 1222. In some embodiments, mirror 1224 is a concave mirror. Connection component 1220 can be attached to connection component 1210 via connectors 1230. More specifically, connectors 1230 can enable connection component 1220 to be detached from connection component 1210. In some embodiments, connectors 1230 are attached to spacer 1218. In some embodiments, connectors 1230 are attached to cladding layer 1212.

Optical signals 1232 can travel through waveguide 1214, which can, upon incidence upon mirror 1216, be directed toward mirror 1224. Upon incidence upon mirror 1224, optical signals 1232 can be coupled to optical fiber 1226. Optical signals 1232 can be coupled to optical fiber 1226 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, width “H” corresponding to the width of cladding layer 1212 ranges between about 20 µm to about 40 µm. In some embodiments, width “H” is about 30 µm. In some embodiments, width “I” corresponding to the width of spacer 1218 ranges between about 200 µm to about 400 µm. In some embodiments, width “I” is about 300 µm.

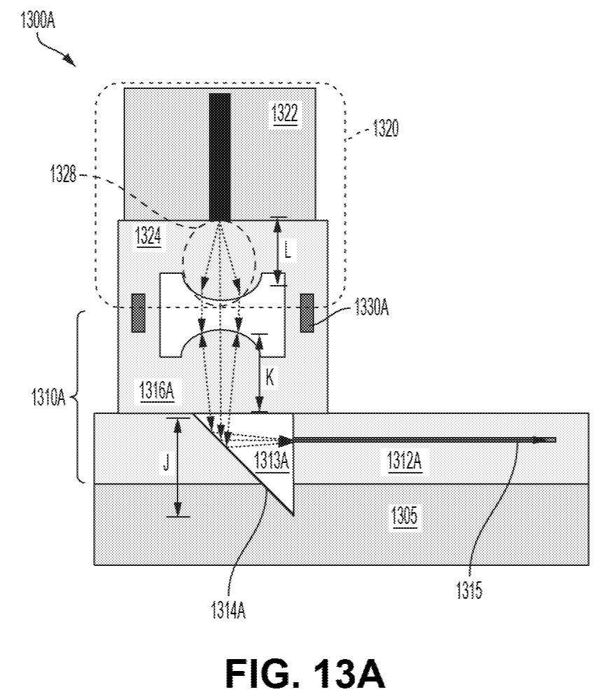

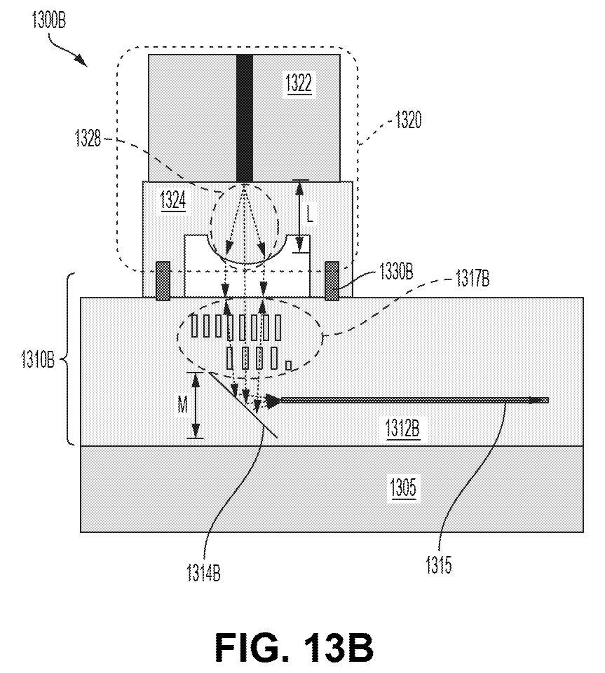

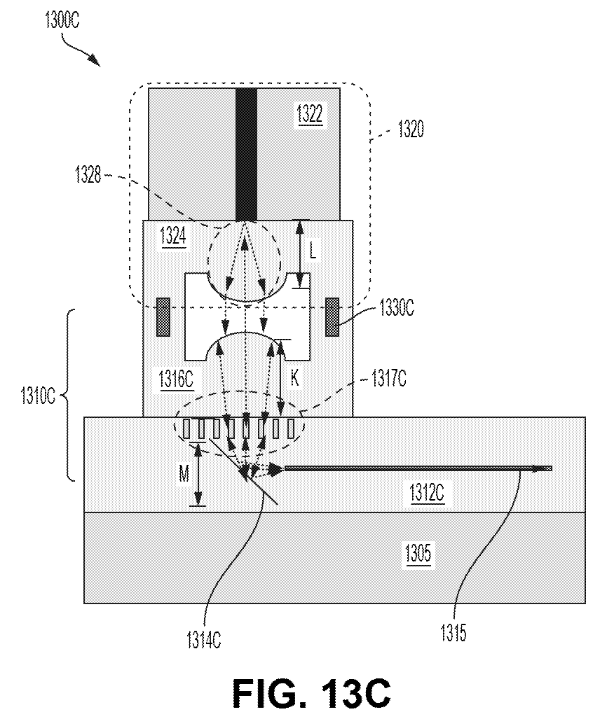

FIG. 13A is a diagram of a device or system 1300A, according to some aspects of the disclosure. As shown in FIG. 13A, system 1300A can include substrate 1305 and connection component 1310A formed on substrate 1305. Connection component 1310A can include cladding layer 1312A formed on substrate 1305, trench 1313A formed at least through cladding layer 1312, mirror 1314A formed (e.g., coated) on a sidewall of trench 1313A, and waveguide 1315 formed within cladding layer 1312A. Trench 1313A can have a triangular cross-sectional shape (e.g., right triangular cross-sectional shape), and mirror 1314A can be formed on an angled sidewall of trench 1313A (e.g., the sidewall corresponding to the hypotenuse of the right triangular cross-sectional shape). In some embodiments, trench 1313A is formed by using a dry etch process. Connection component 1310A can further include microlens 1316A which forms a collimator assembly portion. In some embodiments, trench 1313A is filled with an index matched material (e.g., that matches to the index of cladding layer 1312). The Index matched material may be, for example SiOx, SiN, and/or another material.

System 1300A can further include connection component 1320 corresponding to a detachable optical fiber connector including cleaved optical fiber 1322 formed on microlens 1324. Microlens 1324 can form another collimator assembly portion. The collimator assembly can increase the alignment tolerance of connection component 1320. Accordingly, in these embodiments, the collimator assembly is a microlens assembly. In some embodiments, each lens has a diameter that ranges between about 30 µm to about 100 µm. Connection components 1310A and 1320 can be attached using mechanical connectors 1330A (e.g., pins or tubes).

Optical signals 1328 can travel through cleaved optical fiber 1322 toward the collimator assembly. The collimator assembly can then direct optical signals 1328 toward mirror 1314A. Mirror 1314A can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316A or 1324 is a freeform microlens. For example, at least one of the microlens 1316A or 1324 can be a cylindrical lens if the waveguide mode is elliptical. A freeform microlens can be designed with parametric surfaces, to convert arbitrary mode shape from waveguide to a symmetric circular shape to match the mode at the fiber end.

In some embodiments, distance “J” corresponding to the height of the trench 1313A ranges between about 5 µm to about 15 µm. In some embodiments, distance “J” is about 10 µm. In some embodiments, distance “K” corresponding to the distance between the apex of microlens 1316A and the surface of cladding layer 1312A ranges between about 200 µm to about 600 µm. In some embodiments, distance “K” is about 400 µm. In some embodiments, distance “L” corresponding to the distance between the apex of microlens 1324 and cleaved optical fiber 1322 ranges between about 200 µm to about 600 µm. In some embodiments, distance “L” is about 400 µm.

In some embodiments, the optical fiber 1322 is separated from the microlens 1324 by a gap. In some embodiments, the optical fiber 1322 is separated from the microlens 1324 by one or more layers.

FIG. 13B is a diagram of a device or system 1300B, according to some aspects of the disclosure. As shown in FIG. 13B, system 1300B can include substrate 1305 and connection component 1310B formed on substrate 1305. Connection component 1310B can include cladding layer 1312B formed on substrate 1305, mirror 1314B formed within cladding layer 1312B, and waveguide 1315 formed within cladding layer 1312B. Connection component 1310B can further include metalens array or stack 1317B which forms a collimator assembly portion. In some embodiments, mirror 1314B is formed in a trench formed in cladding layer 1312B, and the trench is then backfilled with an index matched material that is index matched to the cladding layer 1312B after formation of the mirror 1314B.

System 1300B can further include connection component 1320 corresponding to a detachable optical fiber connector including cleaved optical fiber 1322 formed on microlens 1324, as described above with reference to FIG. 13A. Microlens 1324 can form another collimator assembly portion. The metalens array or stack 1317B can be used to achieve lithography-defined overlay accuracy, broadband operation over the entire original band (O-band) (e.g., wavelengths ranging from about 1260 nanometers (nm) to about 1360 nm), and high flexibility of beam shaping. A metalens can be made of any suitable material. Examples of suitable materials include silicon (Si), titanium oxide (TiO₂), etc. The collimator assembly can increase the alignment tolerance of connection component 1320. Accordingly, in these embodiments, the collimator assembly is a hybrid microlens-metalens assembly. In some embodiments, each lens has a diameter that ranges between about 30 µm to about 100 µm. Connection components 1310B and 1320 can be attached using mechanical connectors 1330B (e.g., pins or tubes).

Optical signals 1328 can travel through cleaved optical fiber 1322 toward the collimator assembly. The collimator assembly can then direct optical signals 1328 toward mirror 1314A. Mirror 1314B can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength. In some embodiments, the microlens 1324 is a freeform microlens. For example, microlens 1324 can be a cylindrical lens if the waveguide mode is elliptical.

In some embodiments, distance “M” corresponding to the height of the mirror 1314B is less than or equal to about 10 µm. In some embodiments, the distance “M” is less than or equal to about 6 µm. The distance “L” is similar to the distance “L” described above with reference to FIG. 13A.

In some embodiments, the optical fiber 1322 is separated from the microlens 1324 by a gap. In some embodiments, the optical fiber 1322 is separated from the microlens 1324 by one or more layers.

FIG. 13C is a diagram of a device or system 1300C, according to some aspects of the disclosure. As shown in FIG. 13B, system 1300C can include substrate 1305 and connection component 1310C formed on substrate 1305. Connection component 1310C can include cladding layer 1312C formed on substrate 1305, mirror 1314C formed within cladding layer 1312C, and waveguide 1315 formed within cladding layer 1312C. Connection component 1310C can further include microlens 1316C and metalens array or stack 1317C which forms a collimator assembly portion. The metalens array or stack 1317C can be used to slow down the divergence of light.

System 1300C can further include connection component 1320 corresponding to a detachable optical fiber connector including cleaved optical fiber 1322 formed on microlens 1324, as described above with reference to FIGS. 13A-13B. Microlens 1324 can form another collimator assembly portion. The collimator assembly can increase the alignment tolerance of connection component 1320. Accordingly, in these embodiments, the collimator assembly is a hybrid microlens-metalens assembly. In some embodiments, each lens has a diameter that ranges between about 30 µm to about 100 µm. Connection components 1310C and 1320 can be attached using mechanical connectors 1330C (e.g., pins or tubes).

Optical signals 1328 can travel through cleaved optical fiber 1322 toward the collimator assembly. The collimator assembly can then direct optical signals 1328 toward mirror 1314A. Mirror 1314C can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316C or 1324 is a freeform microlens. For example, at least one of the microlens 1316C or 1324 can be a cylindrical lens if the waveguide mode is elliptical. The distances “M”, “K” and “L” are similar to the distances “K” and “L” described above with reference to FIGS. 13A-13B.

In some embodiments, the optical fiber 1322 is separated from the microlens 1324 by a gap. In some embodiments, the optical fiber 1322 is separated from the microlens 1324 by one or more layers.

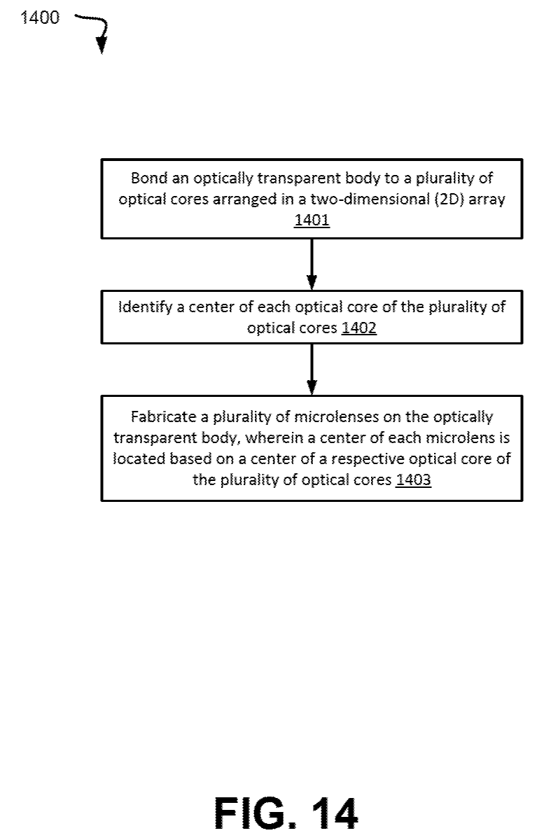

FIG. 14 is a flowchart of an example method 1400 to fabricate a 2D array of microlenses, according to some aspects of the disclosure.

At block 1401, an optically transparent body is bonded to a plurality of optical cores arranged in a two-dimensional (2D) array.

At block 1402, a center of each optical core of the plurality of optical cores is identified.

At block 1403, a plurality of microlenses is fabricated on the optically transparent body. In some embodiments, the center of each microlens of the plurality of microlenses is located based on a center of a respective optical core of the plurality of optical cores. In some embodiments, the microlenses are fabricated using one or more of 3D lithography or 3D microprinting.

Further details regarding blocks 1401-1403 are described above with reference to FIGS. 1A-13.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An optical connector comprising:
a first body comprising a plurality of holes;
a plurality of optical cores inserted into the plurality of holes and arranged in a first two-dimensional (2D) array; and
an optically transparent second body bonded to at least one of the first body or the plurality of optical cores, wherein the second body comprises a first plurality of microlenses, each microlens of the first plurality of microlenses aligned with a respective optical core of the plurality of optical cores such that the first plurality of microlenses are arranged in a second 2D array, wherein a first arrangement of the first 2D array matches a second arrangement of the second 2D array.

2. The optical connector of claim 1 further comprising:
an optical turning element attached to the second body, wherein the optical turning element is configured to redirect an optical signal output by the plurality of optical cores.

3. The optical connector of claim 1, wherein the first 2D array has an aligned pitch.

4. The optical connector of claim 1, wherein the first 2D array has a staggered pitch.

5. The optical connector of claim 1, wherein the optically transparent second body comprises an optical turning element.

6. The optical connector of claim 1, wherein a first pitch along a first axis of the first 2D array is less than 250 micrometers (µm), and wherein a second pitch along a second axis of the first 2D array is less than 250 µm.

7. The optical connector of claim 1, wherein the optical connector is configured to edge couple to a photonic integrated circuit (PIC) comprising a plurality of waveguide turning elements arranged in a third 2D array that matches the first 2D array and the second 2D array, wherein each waveguide turning element of the plurality of waveguide turning elements is configured to redirect an optical signal between a waveguide of a plurality of waveguides and an optical core of the plurality of optical cores.

8. The optical connector of claim 7, wherein the optical connector is configured to removably couple to the PIC.

9. The optical connector of claim 1, wherein the plurality of optical cores comprise a 90 degree bend within the optical connector.

10. A system comprising:
a photonic integrated circuit (PIC) comprising an optical port;
an optical connector comprising:
a first body comprising a plurality of holes;
a plurality of optical cores inserted into the plurality of holes and arranged in a first two-dimensional (2D) array; and
an optically transparent second body bonded to at least one of the first body or the plurality of optical cores, wherein the second body comprises a first plurality of microlenses, each microlens of the first plurality of microlenses aligned with a respective optical core of the plurality of optical cores such that the first plurality of microlenses are arranged in a second 2D array, wherein a first arrangement of the first 2D array matches a second arrangement of the second 2D array.

11. The system of claim 10, wherein the optical port comprises:
an optically transparent third body bonded to the PIC, wherein the third body comprises a second plurality of microlenses, each microlens of the second plurality of microlenses aligned with a respective microlens of the first plurality of microlenses such that the second plurality of microlenses are arranged in a third 2D array, wherein a third arrangement of the third 2D array matches the first arrangement of the first 2D array and the second arrangement of the second 2D array.

12. The system of claim 11, wherein the optical port further comprises:
an optical turning element mechanically affixed to the PIC, wherein the optical turning element is configured to redirect a plurality of optical signals that are output from the first plurality of microlenses.

13. The system of claim 11, wherein the PIC further comprises:
a plurality of waveguides; and
a plurality of waveguide turning elements, wherein each waveguide turning element is configured to optically couple an optical signal between a respective waveguide of the plurality of waveguides and a respective microlens of the second plurality of microlenses.

14. The system of claim 10, further comprising:
an optical turning element attached to the second body, wherein the optical turning element is configured to redirect a plurality of optical signals that are output from the plurality of optical cores.

15. The system of claim 14, wherein the optical turning element comprises the first plurality of microlenses.

16. The system of claim 10, wherein the first plurality of microlenses are manufactured on the second body based on respective positions of the plurality of optical cores arranged in the first 2D array.

17. The system of claim 16, wherein the first plurality of microlenses are manufactured using one or more of three-dimensional (3D) lithography or 3D microprinting.

18. The system of claim 10, wherein an x-direction pitch of the first 2D array is less than 250 micrometers (µm), and wherein a y-direction pitch of the first 2D array is less than 250 µm.

19. A method comprising:
bonding an optically transparent body to a plurality of optical cores arranged in a two-dimensional (2D) array;
identifying a center of each optical core of the plurality of optical cores; and
fabricating a plurality of microlenses on the optically transparent body, wherein a center of each microlens is located based on a center of a respective optical core of the plurality of optical cores.

20. The method of claim 19, wherein fabricating the plurality of microlenses comprises one or more of three-dimensional (3D) lithography or 3D microprinting.
